(19) United States
(12) Patent Application Publication
(10) Pub. No.: US 2015/0258705 A1
(43) Pub. Date: Sep. 17, 2015

(54) MANUFACTURING METHOD OF THREE-DIMENSIONAL STRUCTURE, THREE-DIMENSIONAL STRUCTURE MANUFACTURING APPARATUS, AND THREE-DIMENSIONAL STRUCTURE

(71) Applicant: SEIKO EPSON CORPORATION, Tokyo (JP)

(72) Inventor: Koki HIRATA, Matsumoto (JP)

(21) Appl. No.: 14/638,318

(22) Filed: Mar. 4, 2015

(30) Foreign Application Priority Data
Mar. 12, 2014 (JP) 2014-048527

(51) Int. Cl. B28B 1/00; B28B 13/02; B29C 67/00; B22F 3/00; B22F 1/00

(52) U.S. Cl. CPC B28B 1/001; B22F 3/003; B22F 3/00; B22F 1/0059; B29C 67/0081; B29C 67/0085; B28B 13/02; B33Y 10/00

(57) ABSTRACT

Provided is a manufacturing method of a three-dimensional structure which manufactures a three-dimensional structure by laminating layers, the method including: forming the layers using a composition A containing three-dimensional formation powders and a solvent; discharging a binding solution for binding the three-dimensional formation powders to the layers; binding the three-dimensional formation powders by curing the discharged binding solution; removing the non-bound three-dimensional formation powders using the solvent; and additionally adding the three-dimensional formation powders to a mixed solution generated by the removing and containing the non-bound three-dimensional formation powders and the solvent, and preparing a composition B containing the three-dimensional formation powders and the solvent.

### BACKGROUND

1. Technical Field

The present invention relates to a manufacturing method of a three-dimensional structure, a three-dimensional structure manufacturing apparatus, and a three-dimensional structure.

2. Related Art

In the related art, a method of forming a three-dimensional structure based on a model of a three-dimensional object generated with three-dimensional CAD software or the like has been known, for example.

A laminating method has been known as one method of forming a three-dimensional structure. In the laminating method, a three-dimensional structure is generally formed by dividing a model of a three-dimensional object into a plurality of two-dimensional cross-sectional layers, sequentially forming cross-sectional members corresponding to the two-dimensional cross-sectional layers, and sequentially laminating the cross-sectional members.

With the laminating method, it is possible to immediately form the structure, as long as a model of a three-dimensional structure to be formed is provided, and since it is not necessary to manufacture a mold prior to the formation, it is possible to form a three-dimensional structure in a short period of time at a low cost. In addition, since the structure is formed by laminating thin plate-shaped cross-sectional members one by one, it is even possible to form a complicated object having an internal structure, for example, an integrated structure, without dividing the structure into a plurality of components.

As one of the laminating methods, a technology of forming a three-dimensional structure by solidifying powders with a binding solution has been known (for example, JP-A-06-218712). In this technology, a three-dimensional structure is formed by solidifying at least a part of a layer configured with the powders by the binding solution, laminating the layer, and removing the non-bound powder of the layer.

However, in the method of the related art, the non-bound powder has not been effectively used.

### SUMMARY

An advantage of some aspects of the invention is to provide a manufacturing method of a three-dimensional structure having excellent recycling efficiency of three-dimensional formation powders, a three-dimensional structure manufacturing apparatus having excellent recycling efficiency of three-dimensional formation powders, and a three-dimensional structure which is obtained by the manufacturing method and the manufacturing apparatus.

The invention is realized in the following forms.

According to an aspect of the invention, there is provided a manufacturing method of a three-dimensional structure which manufactures a three-dimensional structure by laminating layers, the method including: forming the layers using a composition A containing three-dimensional formation powders and a solvent; discharging a binding solution for binding the three-dimensional formation powders, to the layers; binding the three-dimensional formation powders by curing the discharged binding solution; removing the non-bound three-dimensional formation powders using the solvent; and additionally adding the three-dimensional formation powders to a mixed solution generated by the removing and containing the non-bound three-dimensional formation powders and the solvent, and preparing a composition B containing the non-bound three-dimensional formation powders and the solvent.

In this case, it is possible to provide a manufacturing method of a three-dimensional structure having excellent recycling efficiency of three-dimensional formation powders.

In the manufacturing method of a three-dimensional structure according to the aspect of the invention, it is preferable that the composition B is prepared by adjusting a viscosity of the composition B based on a viscosity of the composition A, in the preparation of the composition B.

In this case, it is possible to set the concentration of the three-dimensional formation powders in the composition A and the concentration of the three-dimensional formation powders reused in the composition B to be approximately equivalent, and to improve reliability of the layers formed by using the composition B.

In the manufacturing method of a three-dimensional structure according to the aspect of the invention, it is preferable to further include forming the layers using the composition A and the composition B.

In this case, it is possible to more efficiently reuse the composition B.

In the manufacturing method of a three-dimensional structure according to the aspect of the invention, it is preferable to further include a sacrificial layer formation binding solution for forming a sacrificial layer that is discharged to an area of an outermost layer on a surface side, which is adjacent to an area to be the outermost layer of the three-dimensional structure among the layers, and it is preferable that an area of the layer for discharging the sacrificial layer formation binding solution is formed by the composition B.

In this case, it is possible to form the layers with excellent accuracy and it is possible to more efficiently reuse the composition B.

According to another aspect of the invention, there is provided a three-dimensional structure manufacturing apparatus which manufactures a three-dimensional structure by laminating layers, the apparatus including: a formation unit in which the three-dimensional structure is formed; a supply unit which supplies a composition A containing three-dimensional formation powders and a solvent to the formation unit; a layer formation unit which forms the layers in the formation unit using the composition A; a discharge unit which discharges a binding solution for binding the three-dimensional formation powders to the layers; a curing unit which binds the three-dimensional formation powders by curing the discharged binding solution; a removing unit which removes the non-bound three-dimensional formation powders, using the solvent; a storage unit which stores a mixed solution generated by the removing unit and containing the non-bound three-dimensional formation powders and the solvent; and a composition B preparation unit which additionally adds the three-dimensional formation powders to the mixed solution and prepares a composition B containing the three-dimensional formation powders and the solvent.

In this case, it is possible to provide a three-dimensional structure manufacturing apparatus having excellent recycling efficiency of three-dimensional formation powders.

According to still another aspect of the invention, there is provided a three-dimensional structure which is manufactured by the manufacturing method of a three-dimensional structure according to the aspects of the invention.

In this case, it is possible to provide a three-dimensional structure which is produced with excellent efficiency.

According to still another aspect of the invention, there is provided a three-dimensional structure which is manufactured by the three-dimensional structure manufacturing apparatus according to the aspect of the invention.

In this case, it is possible to provide a three-dimensional structure which is produced with excellent efficiency.

### BRIEF DESCRIPTION OF THE DRAWINGS

The invention will be described with reference to the accompanying drawings, wherein like numbers reference like elements.

FIGS. 1A to 1D are schematic views showing each step of a preferred embodiment of a manufacturing method of a three-dimensional structure of the invention.

FIGS. 2A to 2D are schematic views showing each step of a preferred embodiment of a manufacturing method of a three-dimensional structure of the invention.

FIG. 3 is a cross-sectional view schematically showing a state inside of a layer (compositions A and B) immediately before an ink application step.

FIG. 4 is a cross-sectional view schematically showing a state where particles are bound by binding agents.

FIG. 5 is a schematic view showing a preferred embodiment of a three-dimensional structure manufacturing apparatus of the invention.

### DESCRIPTION OF EXEMPLARY EMBODIMENTS

Hereinafter, preferred embodiments of the invention will be described in detail with reference to the accompanying drawings.

### 1. Manufacturing Method of Three-Dimensional Structure

First, a manufacturing method of a three-dimensional structure will be described in detail.

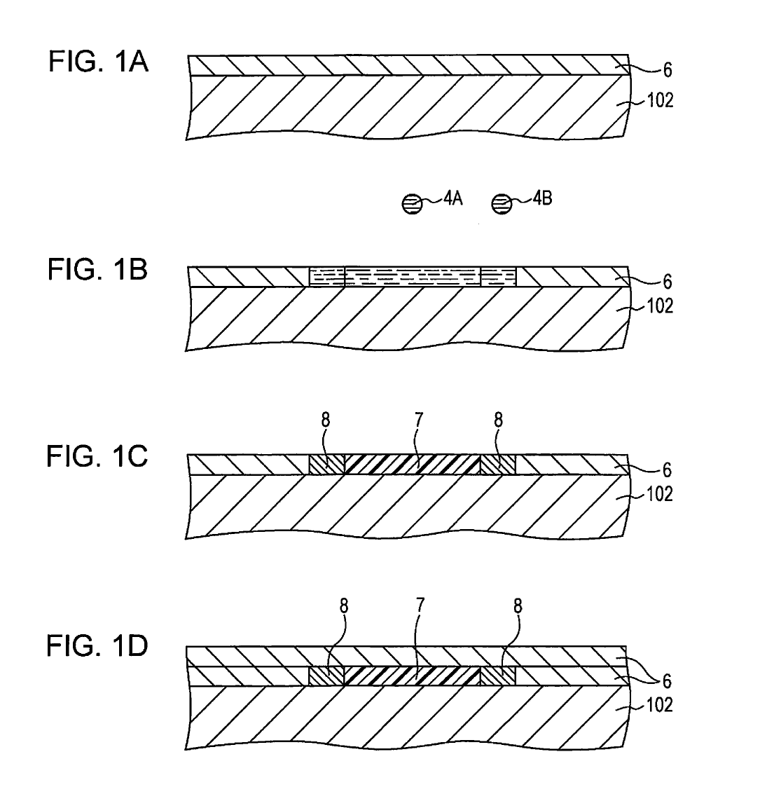

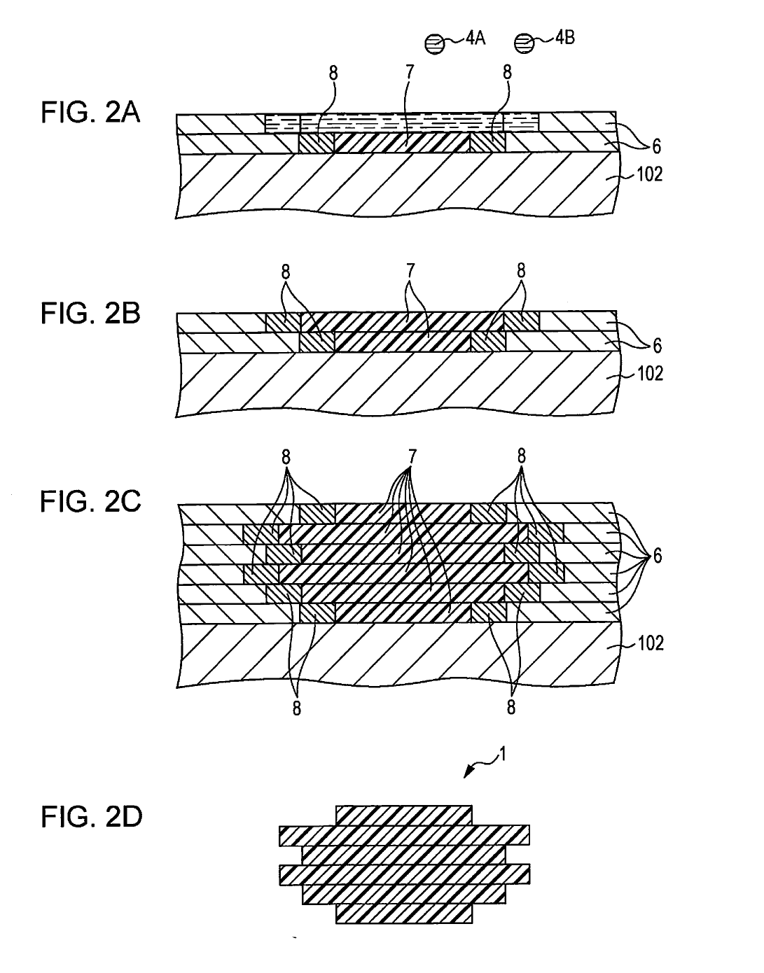

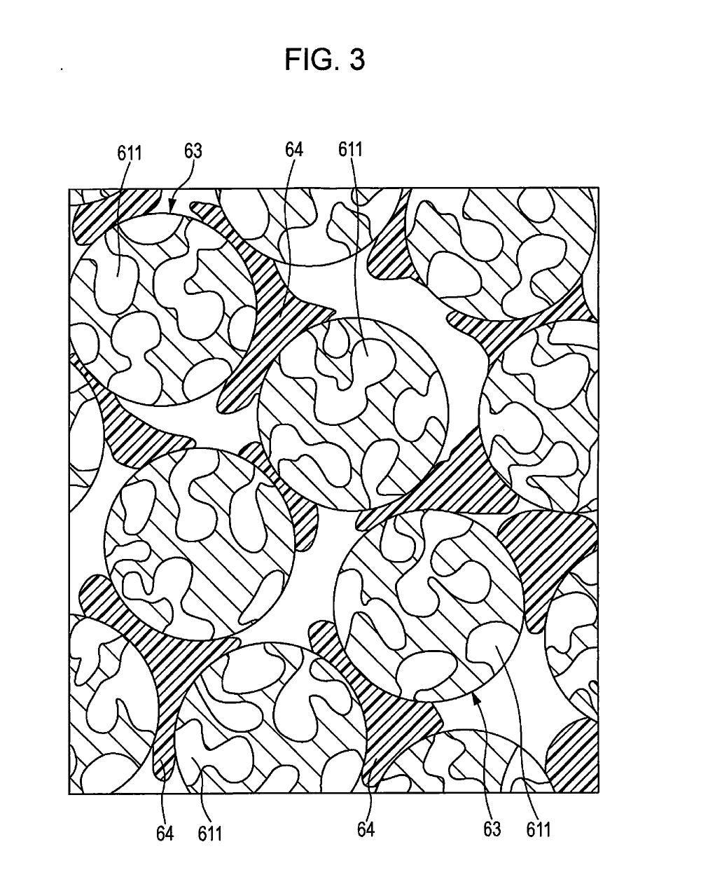

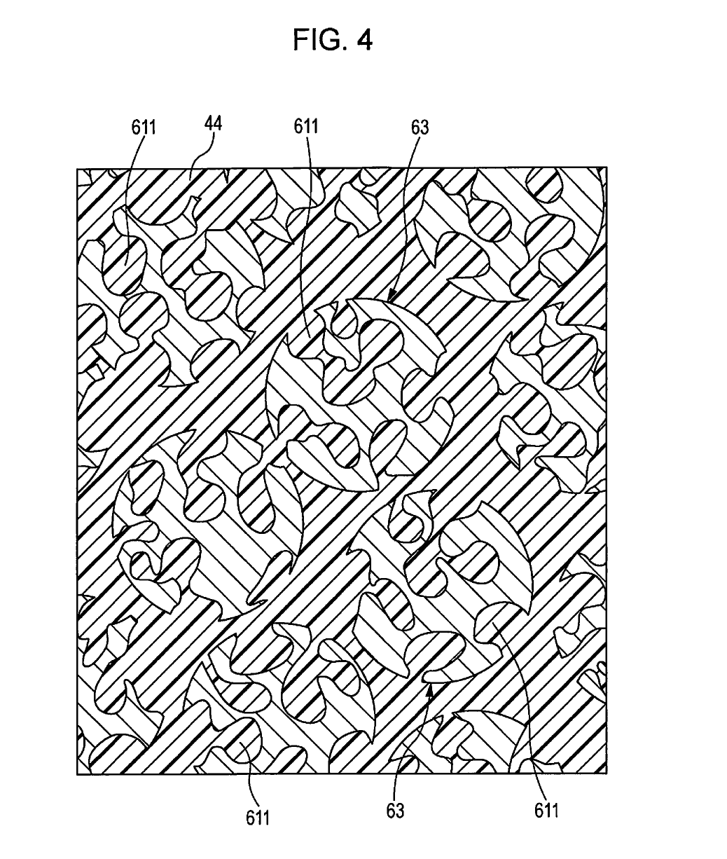

FIGS. 1A to 2D are schematic views showing each step of a preferred embodiment of the manufacturing method of the three-dimensional structure of the invention, FIG. 3 is a cross-sectional view schematically showing a state inside of a layer (compositions A and B) immediately before an ink application step, and FIG. 4 is a cross-sectional view schematically showing a state where particles are bound by binding agents.

As shown in FIGS. 1A to 2D, the manufacturing method of the three-dimensional structure of the embodiment includes a layer formation step (FIGS. 1A and 1D) of forming a layer 6 using a composition containing three-dimensional formation powders and a solvent, a discharge step (FIGS. 1B and 2A) of discharging an actual body formation binding solution 4A containing a binding agent and a sacrificial layer formation binding solution (sacrificial layer formation ink) 4B containing a binding agent to the layer 6 by an ink jet method, and a curing step (FIGS. 1C and 2B) of curing a binding agent 44 contained in the actual body formation binding solution and a binding agent contained in the sacrificial layer formation binding solution applied to the layer 6 and forming a unit layer 7 and a sacrificial layer 8. The above steps are repeatedly performed in this order, and after that, a removing step (FIG. 2D) of removing particles and sacrificial layers 8 bound by the binding solution, among particles 63 configuring each layer 6, using a solvent, is performed.

The manufacturing method of the three-dimensional structure of the embodiment further includes a composition B preparation step of additionally adding the three-dimensional formation powders to the mixed solution which is generated in the above removing step and contains the non-bound three-dimensional formation powders and the solvent, and preparing a composition B containing the three-dimensional formation powders and the solvent.

By including the steps, it is possible to reuse the non-bound three-dimensional formation powders which has been discarded in the related art. As a result, it is possible to provide a manufacturing method of a three-dimensional structure having excellent recycling efficiency of the three-dimensional formation powders.

Hereinafter, each step will be described in detail. Layer Formation Step

First, the layer 6 is formed on the formation stage 102 using the composition containing the three-dimensional formation powders and the solvent (FIG. 1A).

The composition which is used for forming the layer 6 and contains the three-dimensional formation powders and the solvent, may be the composition A containing the unused three-dimensional formation powders and the solvent, may be the composition B containing reused non-cured three-dimensional formation powders, or may be both of the composition A and the composition B. In a case where the layer formation is performed using the composition A and the composition B, it is possible to more efficiently reuse the composition B.

When forming the layer 6 using both the composition A and the composition B, the layer 6 may be formed using a mixture obtained by mixing the composition A and the composition B at an arbitrary mixing ratio, or an arbitrary area of the layer 6 may be formed using any one of the composition A and the composition B.

As will be described later, the composition containing the three-dimensional formation powders and the solvent contains the plurality of particles 63 and a water-soluble resin 64. By containing the water-soluble resin 64, it is possible to bind (temporarily fix) the particles 63 to each other (see FIG. 3) and to effectively prevent unexpected scattering of the particles. Therefore, it is possible to ensure the safety of an operator and improve the dimensional accuracy of the three-dimensional structure 1 to be manufactured.

This step can be performed, for example, by using a method such as a squeegee method, a dispenser method, a screen printing method, a doctor blade method, a spin coating method, or the like.

The thickness of the layer 6 formed in this step is not particularly limited, but is preferably from 30 μm to 500 μm and more preferably from 70 μm to 150 μm. Therefore, it is possible to sufficiently realize excellent productivity of the three-dimensional structure 1, to realize a more effective way to prevent generation of unexpected irregularities on the three-dimensional structure 1 to be manufactured, and to particularly realize excellent dimensional accuracy of the three-dimensional structure 1.

Next, the actual body formation binding solution containing the binding agent 44 and the sacrificial layer formation binding solution containing the binding agent are applied to the layer 6 by the ink jet method (FIG. 1B).

In this step, the actual body formation binding solution 4A is selectively applied to a portion corresponding to the actual body portion (portion having the actual body) of the three-dimensional structure 1 among the layer 6. Accordingly, it is possible to rigidly bind the particles 63 configuring the layer 6 to each other by the binding agent 44, and to realize excellent mechanical strength of the three-dimensional structure 1 to be finally acquired. In a case where the three-dimensional formation compositions (compositions A and B) configuring the layer 6 contain the plurality of porous particles 63, the binding agent 44 is introduced into holes 611 of the particles 63, and an anchor effect is exhibited. As a result, it is possible to realize excellent binding power (binding power through the binding agent 44) for the binding of the particles 63 and to realize excellent mechanical strength of the three-dimensional structure 1 to be finally acquired (see FIG. 4). Since the binding agent 44 configuring the actual body formation binding solution applied in this step is introduced into the holes 611 of the particles 63, it is possible to effectively prevent unexpected wet spreading of the binding solution. As a result, it is possible to have higher dimensional accuracy of the three-dimensional structure 1 to be finally acquired.

In this step, the sacrificial layer formation binding solution is selectively applied to the portion corresponding to the sacrificial layer 8 among the layer 6. By forming the sacrificial layer 8, it is possible to realize fine sense of texture such as a mat tone or a gloss tone, on an outer surface of the three-dimensional structure 1.

In this step, since the actual body formation binding solution and the sacrificial layer formation binding solution are applied by the ink jet method, it is possible to apply the actual body formation binding solution and the sacrificial layer formation binding solution with excellent reproducibility, even when an application pattern of the actual body formation binding solution and the sacrificial layer formation binding solution is a fine shape. As a result, it is possible to have particularly high dimensional accuracy of the three-dimensional structure 1 to be finally acquired.

The actual body formation binding solution and the sacrificial layer formation binding solution will be described later.

### Curing Step (Unit Layer Formation Step)

Then, curable components contained in the actual body formation binding solution and the sacrificial layer formation binding solution discharged to the layer 6 are cured (FIGS. 1C and 1D). Accordingly, the unit layer 7 and the sacrificial layer 8 are obtained. Therefore, it is possible to realize particularly excellent binding strength between the binding agent 44 and the particles 63, and thus, it is possible to realize particularly excellent mechanical strength of the three-dimensional structure 1 to be finally acquired.

This step is performed differently depending on the types of the curing component (binding agent). For example, when the curing component (binding agent) is a thermosetting component, it is possible to perform the step by heating, and when the curing component (binding agent) is a photo-curable component, it is possible to perform the step by irradiation of the corresponding light (for example, when the curing component is an ultraviolet curable component, it is possible to perform the step by irradiation of an ultraviolet ray).

The discharge step and the curing step may be simultaneously performed. That is, the curing reaction may proceed sequentially from the portion to which each binding solution is applied, before the entire pattern of one entire layer 6 is formed.

After that, a sequence of the above steps is repeatedly performed (see FIGS. 1D, 2A, and 2B). Accordingly, among each layer 6, the particles 63 in the portion having the actual body formation binding solution and the sacrificial layer formation binding solution applied thereto, are bound to each other, and a laminate obtained by laminating the plurality of layers 6 in such a state is obtained (see FIG. 2C).

Each binding solution applied to the layer 6 in the second or subsequent binding solution discharge step (see FIG. 2D) is used for the binding of the particles 63 configuring the layer 6, and a part of each binding solution applied permeates a layer 6 lower than the above layer 6. Accordingly, each binding solution is not only used for the binding of the particles 63 in each layer 6, but is also used for the binding of the particles 63 between the adjacent layers. As a result, the three-dimensional structure 1 to be finally acquired has excellent mechanical strength over the entire structure.

### Non-Bound Particles and Sacrificial Layer Removing Step

After repeatedly performing a series of the above steps, a sacrificial layer removing step (FIG. 2D) of removing the non-bound particles by the binding agent 44 among the particles 63 configuring each layer 6, and the sacrificial layer 8 is performed as a post-treatment step. Accordingly, the three-dimensional structure 1 is produced.

In this step, the removing of the non-bound particles and the sacrificial layer 8 is performed by applying the solvent contained in the composition A. In addition, in this step, the non-bound three-dimensional formation powders (non-bound powders) are collected as the mixed solution with the solvent. Accordingly, in the composition B preparation step which will be described later, it is possible to easily reuse the non-bound three-dimensional formation powders, by adding the non-bound three-dimensional formation powders to the mixed solution and adjusting the concentration. The solvent will be described later.

The application method of the solvent is not particularly limited, but a dipping method, a spraying method, a coating method, or various printing methods can be employed.

Ultrasonic vibration may be applied when removing the non-bound particles and the sacrificial layer 8. Accordingly, it is possible to promote the removal of the non-bound particles and the sacrificial layer 8, and to realize particularly excellent productivity of the three-dimensional structure 1.

### Composition B Preparation Step

In this step, the unused three-dimensional formation powders are added to the mixed solution containing the non-bound particles removed in the above removing step and the solvent, and the composition B containing the three-dimensional formation powders and the solvent is prepared. The composition B obtained in this step is used for the formation of the layer 6 in the layer formation step described above.

In this step, it is preferable to adjust the viscosity of the composition B based on the viscosity of the composition A. That is, it is preferable to adjust the viscosity of the composition B to be equivalent to the viscosity of the composition A. It is preferable to adjust the viscosity of the composition B to be in a range of ±30% of the viscosity of the composition A, and it is preferable to adjust the viscosity of the composition B to be in a range of ±10% thereof. Therefore, it is possible to set the concentration of the three-dimensional formation powders in the composition A and the concentration of the three-dimensional formation powders in the composition B to be approximately equivalent, and to improve reliability of the layers formed by using the composition B.

The composition B obtained in this step is preferably used in a portion that will become the sacrificial layers 8 described above, among the layer 6. Therefore, it is possible to accurately form the layer 6 and to more efficiently reuse the composition B.

### 2. Three-Dimensional Structure Manufacturing Apparatus

Next, a three-dimensional structure manufacturing apparatus of the invention will be described.

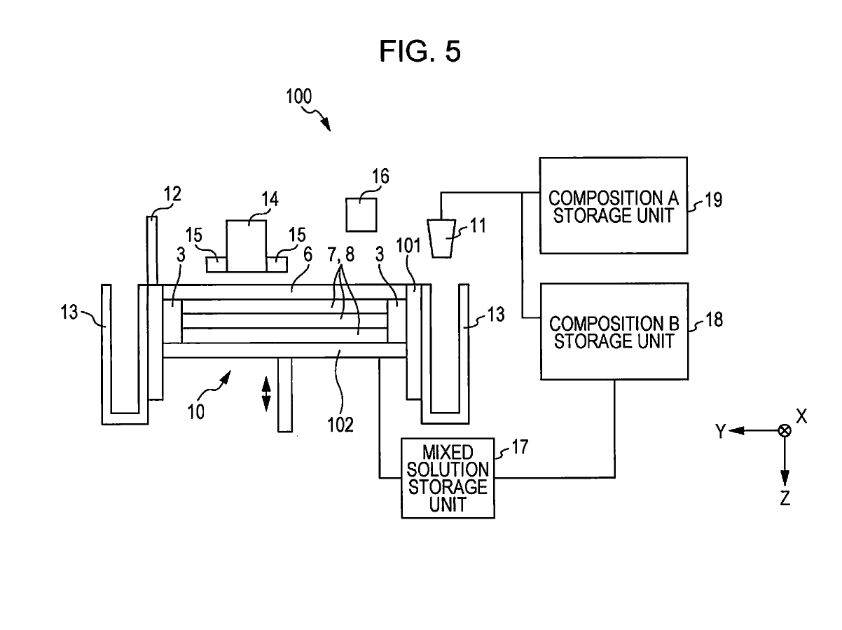

FIG. 5 is a schematic view showing a preferred embodiment of a three-dimensional structure manufacturing apparatus of the invention.

A three-dimensional structure by laminating unit layers 7 by using three-dimensional formation compositions (composition A and composition B) containing three-dimensional formation powders.

As shown in FIG. 5, the three-dimensional structure manufacturing apparatus 100 includes a formation unit 10 in which a three-dimensional structure is formed, a supply unit 11 which supplies compositions A and B containing three-dimensional formation powder and a solvent, a squeegee (layer formation unit) 12 which forms a layer 6 of the three-dimensional formation composition on the formation unit 10 using the supplied three-dimensional formation compositions (composition A and composition B), a collection unit 13 which collects the excess of the three-dimensional formation composition when forming the layer 6, a discharge unit 14 which discharges a binding solution to the layer 6, an ultraviolet ray irradiation unit 15 which emits an ultraviolet ray for curing the binding solution discharged to the layer 6, a removing unit 16 which removes the non-bound three-dimensional formation powders by supplying the solution, a mixed solution storage unit 17 which collects and stores a mixed solution containing the removed non-bound three-dimensional formation powders and the solvent, a composition B preparation unit 18 which prepares the composition B by additionally adding the three-dimensional formation powders to the collected mixed solution, and a composition A storage unit 19 which stores the composition A. The three-dimensional formation compositions (composition A and composition B) and the binding solution will be described later.

As shown in FIG. 5, the formation unit 10 includes a frame body 101 and a formation stage 102 provided in the frame body 101.

The frame body 101 is configured with a frame-shaped member.

The formation stage 102 has a rectangular shape in the XY plane.

The formation stage 102 is configured to be driven (moved up and down) in a Z axis direction by a driving unit (not shown).

The layer 6 is formed in an area which is formed with an inner wall surface of the frame body 101 and the formation stage 102.

The supply unit 11 includes a function of supplying the composition A and the composition B to the formation stage 102. In the embodiment, the supply unit 11 employs a dispenser method. By employing the dispenser method, the composition A and the composition B can be appropriately applied.

The supply unit 11 is connected to the composition A storage unit 19 which stores the composition A and is configured so that the composition A is supplied from the composition A storage unit 19.

In addition, the supply unit 11 is connected to the composition B preparation unit 18 which will be described later and is configured so that the composition B is supplied from the composition B preparation unit 18.

The squeegee (layer formation unit) 12 has an elongated plate shape in an X axis direction. The squeegee 12 is configured so as to be driven by the driving unit (not shown) in a Y axis direction. A tip of the squeegee 12 in a short axis direction is configured to come into contact with an upper surface of the frame body 101.

The squeegee 12 forms the layer 6 on the formation stage 102 with the compositions A and B supplied to the upper portion of the formation stage 102 while moving in the Y axis direction.

The collection unit 13 is a box-shaped member having an opened upper surface. The collection unit 13 has a function of collecting the excess of the three-dimensional formation compositions (composition A and composition B) in the formation of the layer 6.

Two collection units 13 are provided. Both of the two collection units 13 are connected to the frame body 101 and are provided so as to face each other with the frame body 101 interposed therebetween.

The excess of the compositions A and B carried by the squeegee 12 are collected by the collection units 13 and the collected three-dimensional formation compositions (composition A and composition B) are provided for reuse.

Adjustment of a thickness of the layer 6 is performed by adjustment of an amount of descent of the formation stage 102 or adjustment of a position of the squeegee 12.

The discharge unit 14 has a function of discharging an actual body formation binding solution and a sacrificial layer formation binding solution to the formed layer 6.

A liquid droplet discharge head which discharges liquid droplets of each binding solution by an ink jet method is mounted on the discharge unit 14. The discharge unit 14 includes a binding solution supply unit (not shown). In the embodiment, a so-called piezoelectric drive type liquid droplet discharge head is employed.

The ultraviolet ray irradiation unit (curing unit) 15 is provided in a vicinity of the discharge unit 14 and has a function of curing each binding solution discharged to the layer 6.

The removing unit 16 has a function of supplying a solvent to the formation stage 102, in order to remove the non-bound three-dimensional formation powders and sacrificial layers 8, after a three-dimensional structure 1 is formed. In addition, the removing unit can also be used for removing foreign materials attached to the formation stage 102, prior to the supplying of the three-dimensional formation compositions to the upper portion of the formation stage 102.

The mixed solution storage unit 17 is configured to collect and store a mixed solution which is generated by the removing unit 16 and contains the non-bound three-dimensional formation powders and the solvent.

The composition B preparation unit 18 is configured to adjust the concentration (viscosity) by adding the three-dimensional formation powders to the mixed solution stored in the mixed solution storage unit 17 and prepares the composition B.

The composition B prepared by the composition B preparation unit 18 is supplied to the supply unit 11 through piping.

In the three-dimensional structure manufacturing apparatus 100 described above, it is possible to easily reuse the non-bound three-dimensional formation powders.

In the above-mentioned description, a case where the squeegee 12 is used as the layer formation unit has been described, but the layer formation unit is not limited to the squeegee, and a roller may be used, for example.

A removing unit which removes the three-dimensional formation compositions (composition A and composition B) attached to the squeegee 12 may be provided in the collection unit 13. Ultrasonic waves, wipers, static electricity, or the like can be used as the removing unit.

### 3. Three-Dimensional Formation Compositions (Composition A and Composition B)

Next, the compositions A and B will be described in detail.

The compositions A and B contain the three-dimensional formation powders and the solvents.

Hereinafter, each component will be described in detail.

### Three-Dimensional Formation Powders

The three-dimensional formation powders are configured with the plurality of particles.

Any particles can be used as the particles, but the particles are preferably configured with porous particles. Accordingly, it is possible to make the binding agent in the binding solution suitably permeate the inside of the holes, when manufacturing the three-dimensional structure, and therefore, it is possible to preferably use the particles in manufacturing the three-dimensional structure having excellent mechanical strength.

As a constituent material of the porous particles configuring the three-dimensional formation particles, an inorganic material or an organic material, or a complex of these is used, for example.

Examples of the inorganic material configuring the porous particles include various metals or metal compounds. Examples of the metal compounds include various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbide such as silicon carbide and titanium carbide; various metal sulfide such as zinc sulfide; various metal carbonates such as calcium carbonate and magnesium carbonate; various metal sulfates such as calcium sulfate and magnesium sulfate; various metal silicates such as calcium silicate and magnesium silicate; various metal phosphates such as calcium phosphate; various metal borates such as aluminum borate and magnesium borate; and a composite compound thereof.

Examples of the organic material configuring the porous particles include a synthetic resin and a natural polymer, and specific examples thereof include a polyethylene resin; polypropylene; polyethylene oxide; polypropylene oxide; polyethylene imine; polystyrene; polyurethane; polyurea; polyester; a silicone resin; an acrylic silicone resin; a polymer having ester (meth)acrylate such as methyl polymethacrylate as a constituent monomer; a crosspolymer having (meth)acrylate such as a methyl methacrylate crosspolymer as a constituent monomer (such as an ethylene-acrylic acid copolymer resin); a polyamide resin such as nylon 12, nylon 6, or copolymer nylon; polyimide; carboxymethyl cellulose; gelatin; starch; chitin; and chitosan.

Among these, the porous particles are preferably configured with the inorganic material, and more preferably configured with metal oxide, and even more preferably configured with silica. Therefore, it is possible to realize particularly excellent properties such as mechanical strength and light resistance of the three-dimensional structure. Particularly, when the porous particles are configured with silica, the effects described above are more significantly exhibited. Since silica has also excellent fluidity, it is advantageous in forming the layer 6 having higher uniformity in thickness and it is possible to realize particularly excellent productivity and dimensional accuracy of the three-dimensional structure.

As silica, a product commercially available in a market can be preferably used. Specific examples thereof include MIZKASIL P-526, MIZKASIL P-801, MIZKASIL NP-8, MIZKASIL P-802, MIZKASIL P-802Y, MIZKASIL C-212, MIZKASIL P-73, MIZKASIL P-78A, MIZKASIL P-78F, MIZKASIL P-87, MIZKASIL P-705, MIZKASIL P-707, MIZKASIL P-707D, MIZKASIL P-709, MIZKASIL C-402, MIZKASIL C-484 (all manufactured by Mizusawa Industrial Chemicals, Ltd.), TOKUSIL U, TOKUSIL UR, TOKUSIL GU, TOKUSIL AL-1, TOKUSIL GU-N, TOKUSIL N, TOKUSIL NR, TOKUSIL PR, SOLEX, FINESIL E-50, FINESIL T-32, FINESIL X-30, FINESIL X-37, FINESIL X-37B, FINESIL X-45, FINESIL X-60, FINESIL X-70, FINESIL RX-70, FINESIL A, FINESIL B (all manufactured by Tokuyama Corporation), SIPERNAT, CARPLEX FPS-101, CARPLEX CS-7, CARPLEX 22S, CARPLEX 80, CARPLEX 80D, CARPLEX XR, CARPLEX 67 (all manufactured by DSL JAPAN Co., Ltd.), SYLOID 63, SYLOID 65, SYLOID 66, SYLOID 77, SYLOID 74, SYLOID 79, SYLOID 404, SYLOID 620, SYLOID 800, SYLOID 150, SYLOID 244, SYLOID 266 (all manufactured by Fuji Silysia Chemical Ltd.), NIPGEL AY-200, NIPGEL AY-6A2, NIPGEL AZ-200, NIPGEL AZ-6A0, NIPGEL BY-200, NIPGEL CX-200, NIPGEL CY-200, Nipsil E-150J, Nipsil E-220A, and Nipsil E-200A (all manufactured by Tosoh Silica Corporation).

The porous particles are preferably subjected to hydrophobic treatment. Meanwhile, the binding agent contained in the binding solution generally tends to have hydrophobicity. Accordingly, since the porous particles are subjected to the hydrophobic treatment, it is possible make the binding agent suitably permeate the inside of the holes of the porous particles. As a result, an anchor effect is more significantly exhibited, and it is possible to realize more excellent mechanical strength of the three-dimensional structure to be acquired. In addition, when the porous particles are subjected to the hydrophobic treatment, it is possible to preferably reuse the porous particles. For more specific description, when the porous particles are subjected to the hydrophobic treatment, affinity between the water-soluble resin which will be described later and the porous particles decreases, and therefore the introduction of the water-soluble resin into the holes is prevented. As a result, in the manufacturing of the three-dimensional structure, it is possible to easily remove impurities in the porous particles in an area with no binding solution applied, by washing with water or the like, and it is possible to collect the particles with high purity. Thus, by mixing the collected three-dimensional formation powders with the water-soluble resin at a predetermined ratio again, it is possible to obtain the three-dimensional formation powders reliably controlled to have a desired composition.

Any treatment may be performed as the hydrophobic treatment performed for the porous particles configuring the three-dimensional formation powders, as long as it is treatment for increasing hydrophobicity of the porous particles, and it is preferable to introduce a hydrocarbon group. Accordingly, it is possible to further increase the hydrophobicity of the particles. In addition, it is possible to easily and reliably increase uniformity of the degree of the hydrophobic treatment on each particle and each portion of the particle surface (including surface of the inside of the hole).

A compound used in the hydrophobic treatment is preferably a silane compound including a silyl group. Specific examples of the compound which can be used in the hydrophobic treatment include hexamethyldisilazane, dimethyldimethoxysilane, diethyl diethoxysilane, 1-propenyl methyl dichlorosilane, propyl dimethyl chlorosilane, propyl methyl dichlorosilane, propyl trichlorosilane, propyl triethoxysilane, propyl trimethoxysilane, styrylethyltrimethoxysilane, tetradecyl trichlorosilane, 3-thiocyanate propyl triethoxysilane, p-tolyl dimethyl chlorosilane, p-tolyl methyl dichlorosilane, p-tolyl trichlorosilane, p-tolyl trimethoxysilane, p-tolyl triethoxysilane, di-n-propyl di-n-propoxysilane, diisopropyl diisopropoxy silane, di-n-butyl di-n-butyroxy silane, di-sec-butyl di-sec-butyroxy silane, di-t-butyl di-t-butyroxy silane, octadecyl trichlorosilane, octadecyl methyldiethoxysilane, octadecyltriethoxysilane, octadecyltrimethoxysilane, octadecyldimethylchlorosilane, octadecyl methyl dichlorosilane, octadecyl methoxy dichlorosilane, 7-octenyl dimethyl chlorosilane, 7-octenyl trichlorosilane, 7-octenyl trimethoxysilane, octyl methyl dichlorosilane, octyl dimethyl chlorosilane, octyl trichlorosilane, 10-undecenyl dimethyl chlorosilane, undecyl trichlorosilane, vinyl dimethyl chlorosilane, methyl octadecyl dimethoxy silane, methyl dodecyl diethoxysilane, methyl octadecyl dimethoxy silane, methyl octadecyl diethoxy silane, n-octyl methyl dimethoxy silane, n-octyl methyldiethoxysilane, triacontyl dimethylchlorosilane, triacontyl trichlorosilane, methyl trimethoxysilane, methyl triethoxysilane, methyl tri-n-propoxysilane, methyl isobutyl propoxysilane, methyl-n-butyroxy silane, methyltri-sec-butyroxy silane, methyltri-t-butyroxy silane, ethyl trimethoxysilane, ethyl triethoxysilane, ethyltri-n-propoxysilane, ethyl iso-propoxysilane, ethyl-n-butyroxy silane, ethyltri-sec-butyroxy silane, ethyltri-t-butyroxy silane, n-propyl trimethoxy silane, isobutyl trimethoxysilane, n-hexyl trimethoxysilane, hexadecyl trimethoxysilane, n-octyl trimethoxysilane, n-dodecyl trimethoxysilane, n-octadecyl trimethoxysilane, n-propyl triethoxysilane, isobutyl triethoxysilane, n-hexyl triethoxysilane, hexadecyl triethoxysilane, n-octyl triethoxysilane, n-dodecyl trimethoxysilane, n-octadecyltriethoxysilane, 2-[2-(trichlorosilyl)ethyl]pyridine, 4-[2-(trichlorosilyl)ethyl]pyridine, diphenyldimethoxysilane, diphenyldiethoxysilane, 1,3 (trichlorosilyl methyl) heptacosane, dibenzyl dimethoxy silane, dibenzyl diethoxy silane, phenyl trimethoxysilane, phenyl methyl dimethoxy silane, phenyl dimethyl methoxy silane, phenyl dimethoxy silane, phenyl diethoxysilane, phenyl methyldiethoxysilane, phenyl dimethylethoxysilane, benzyl triethoxysilane, benzyl trimethoxysilane, benzyl methyl dimethoxy silane, benzyl dimethyl methoxy silane, benzyl dimethoxy silane, benzyl diethoxysilane, benzyl methyldiethoxysilane, benzyl dimethyl ethoxy silane, benzyl triethoxysilane, dibenzyl dimethoxy silane, dibenzyl diethoxy silane, 3-acetoxymethyl-propyl trimethoxy silane, 3-acryloxypropyl trimethoxysilane, allyl trimethoxysilane, allyl triethoxysilane, 4-aminobutyl triethoxysilane, (aminoethyl aminomethyl) phenethyl trimethoxy silane, N-(2-aminoethyl)-3-amino propyl methyl dimethoxy silane, N-(2-aminoethyl)-3-aminopropyltrimethoxysilane, 6-(aminohexyl aminopropyl) trimethoxysilane, p-aminophenyl trimethoxysilane, p-aminophenyl ethoxysilane, m-aminophenyl trimethoxysilane, m-aminophenyl ethoxysilane, 3-aminopropyltrimethoxysilane, 3-aminopropyltriethoxysilane, co-amino undecyl trimethoxysilane, amyl triethoxysilane, benzoxathiepin dimethyl ester, 5-(bicycloheptenyl) triethoxysilane, bis(2-hydroxyethyl)-3-aminopropyl triethoxysilane, 8-bromo-octyl trimethoxy silane, bromophenyl trimethoxy silane, 3-bromopropyl trimethoxy silane, n-butyl trimethoxysilane, 2-chloromethyl-triethoxysilane, chloromethyl methyl diethoxysilane, chloromethyl methyl diisopropoxy silane, p-(chloromethyl) phenyl trimethoxy silane, chloromethyl triethoxysilane, chlorophenyl triethoxysilane, 3-chloropropyl methyl dimethoxy silane, 3-chloropropyl triethoxysilane, 3-chloropropyl trimethoxysilane, 2-(4-chloro-sulfonyl-phenyl) ethyl trimethoxysilane, 2-cyanoethyl triethoxysilane, 2-cyanoethyl trimethoxy silane, cyanomethyl phenethyl triethoxysilane, 3-cyanopropyl triethoxysilane, 2-(3-cyclohexenyl)ethyltrimethoxysilane, 2-(3-cyclohexenyl) ethyltriethoxysilane, 3-cyclohexenyl trichlorosilane, 2-(3-cyclohexenyl) ethyl trichlorosilane, 2-(3-cyclohexenyl) ethyl dimethyl chloro silane, 2-(3-cyclohexenyl) ethyl methyl dichloro silane, cyclohexyl dimethyl chlorosilane, cyclohexylethyldimethoxysilane, cyclohexyl methyl dichlorosilane, cyclohexyl methyl dimethoxy silane, (cyclohexylmethyl) trichlorosilane, cyclohexyl trichlorosilane, cyclohexyl trimethoxysilane, cyclooctyl trichlorosilane, (4-cyclooctenyl) trichlorosilane, cyclopentyl trichlorosilane, cyclopentyl trimethoxysilane, 1,1-diethoxy-1-silacyclopenta-3-ene, 3-(2,4-dinitrophenyl amino) propyl triethoxysilane, (dimethylchlorosilyl)methyl-7,7-dimethyl norpinane, (cyclohexylamino methyl) methyldiethoxysilane, (3-cyclopentadienyl propyl) triethoxysilane, N, N-diethyl-3-aminopropyl) trimethoxysilane, 2-(3,4-epoxycyclohexyl) ethyl trimethoxysilane, 2-(3,4-epoxycyclohexyl) ethyl triethoxysilane, (furfuryl oxymethyl) triethoxysilane, 2-hydroxy-4-(3-ethoxy propoxy) diphenyl ketone, 3-(p-methoxyphenyl) propyl methyl dichlorosilane, 3-(p-methoxyphenyl) propyl trichlorosilane, p-(methylphenethyl) methyl dichlorosilane, p-(methylphenethyl) trichlorosilane, p-(methylphenethyl) dimethyl chlorosilane, 3-morpholino-propyl trimethoxy silane, (3-glycidoxypropyl) methyldiethoxysilane, 3-glycidoxypropyl trimethoxysilane, 1,2,3,4,7,7,-hexachloro-6-methyl diethoxysilyl-2-norbornene, 1,2,3,4,7,7,-hexachloro-6-triethoxysilyl-2-norbornene, 3-iodo-propyl trimethoxysilane, 3-isocyanate propyl triethoxysilane, (mercaptomethyl) methyldiethoxysilane, 3-mercaptopropylmethyl dimethoxysilane, 3-mercaptopropyl silane, 3-mercaptopropyl triethoxysilane, 3-methacryloxypropyl methyl diethoxysilane, 3-methacryloxypropyl trimethoxysilane, methyl {2-(3-trimethoxysilyl propylamino) ethylamino}-3-propionate, 7-octenyl trimethoxysilane, R—N-α-phenethyl-N′-triethoxysilylpropyl urea, S—N-α-phenethyl-N′-triethoxysilylpropyl urea, phenethyltrimethoxysilane, phenethyl methyldimethoxysilane, phenethyl dimethyl methoxysilane, phenethyl dimethoxy silane, phenethyl diethoxymethylsilane, phenethyl methyldiethoxysilane, phenethyl dimethylethoxysilane, phenethyl ethoxy silane, (3-phenylpropyl) dimethyl chlorosilane, (3-phenylpropyl) methyl dichlorosilane, N-phenyl aminopropyltrimethoxysilane, N-(triethoxysilyl propyl) dansylamide, N-(3-triethoxysilyl propyl)-4,5-dihydro-imidazole, 2-(triethoxysilylethyl)-5-(chloro acetoxymethyl) bicycloheptane, (S)—N-triethoxysilylpropyl-O-ment carbamate, 3-(triethoxysilyl propyl)-p-nitrobenzamide, 3-(triethoxysilyl) propyl succinic anhydride, N-[5-(trimethoxysilyl)-2-aza-1-oxo-pentyl]caprolactam, 2-(trimethoxysilylethyl) pyridine, N-(trimethoxysilylethyl) benzyl-N,N,N-trimethyl ammonium chloride, phenyl vinyl diethoxysilane, 3-thiocyanate propyl triethoxysilane, (tridecafluoro-1,1,2,2,-tetrahydrocannabinol octyl) triethoxysilane, N-{3-(triethoxysilyl) propyl}phthalamide acid, (3,3,3-trifluoropropyl) methyl dimethoxy silane, (3,3,3-trifluoropropyl) trimethoxysilane, 1-trimethoxysilyl-2-(chloromethyl) phenyl ethane, 2-(trimethoxysilyl) ethyl phenyl sulfonyl azide, β-trimethoxysilylethyl-2-pyridine, trimethoxysilylpropyl diethylene triamine, N-(3-trimethoxysilylpropyl) pyrrole, N-trimethoxysilylpropyl-N,N,N-tributyl ammonium bromide, N-trimethoxysilylpropyl-N,N,N-tributyl ammonium chloride, N-trimethoxysilylpropyl-N,N,N-trimethylammonium chloride, vinyl methyl diethoxy silane, vinyl triethoxysilane, vinyl trimethoxysilane, vinylmethyldimethoxysilane, vinyl dimethyl silane, vinyl dimethyl silane, vinyl methyl dichlorosilane, vinyl phenyl dichlorosilane, vinyl phenyl diethoxysilane, vinyl phenyl dimethyl silane, vinyl phenyl methyl chloro silane, vinyl triphenoxy silane, vinyl tris-t-butoxysilane, adamantylethyl trichlorosilane, allyl phenyl trichlorosilane, (aminoethyl aminomethyl) phenethyl trimethoxy silane, 3-aminophenoxy-dimethyl vinyl silane, phenyl trichlorosilane, phenyl dimethyl chlorosilane, phenylmethyldichlorosilane, benzyl trichlorosilane, benzyl dimethyl chlorosilane, benzyl methyl dichlorosilane, phenethyl diisopropylchlorosilane, phenethyl trichlorosilane, phenethyl dimethyl chlorosilane, phenethylmethyldichlorosilane, 5-(bicycloheptenyl) trichlorosilane, 5-(bicyclo heptenyl) triethoxysilane, 2-(bicycloheptyl) dimethylchlorosilane, 2-(bicycloheptyl) trichlorosilane, 1,4-bis(trimethoxysilyl ethyl) benzene, bromophenyl trichloro silane, 3-phenoxy propyl dimethyl chlorosilane, 3-phenoxypropyl trichlorosilane, t-butyl phenyl chlorosilane, t-butyl phenyl methoxy silane, t-butyl phenyl dichlorosilane, p-(t-butyl) phenethyl dimethyl chlorosilane, p-(t-butyl) phenethyl trichlorosilane, 1,3 (chlorodimethylsilyl methyl) heptacosane, ((chloromethyl) phenyl ethyl) dimethyl chlorosilane, ((chloromethyl) phenylethyl) methyldichlorosilane, ((chloromethyl) phenylethyl) trichlorosilane, ((chloromethyl) phenylethyl) trimethoxysilane, chlorophenyl trichlorosilane, 2-cyanoethyl trichlorosilane, 2-cyano ethyl methyl dichlorosilane, 3-cyanopropyl methyldiethoxysilane, 3-cyanopropyl methyl dichlorosilane, 3-cyanopropyl methyl dichlorosilane, 3-cyanopropyl dimethylethoxysilane, 3-cyanopropyl methyl dichlorosilane, 3-cyanopropyl trichlorosilane, fluoride alkylsilane, and one kind or a combination of two or more kinds selected from these can be used.

Among these, hexamethyldisilazane is preferably used in the hydrophobic treatment. Accordingly, it is possible to further increase the hydrophobicity of the particles. In addition, it is possible to easily and reliably increase uniformity of the degree of the hydrophobic treatment on each particle and each portion of the particle surface (including surface of the inside of the hole).

In a case of performing the hydrophobic treatment using the silane compound in a liquid phase, the particles to be subjected to the hydrophobic treatment are immersed in liquid containing the silane compound, and accordingly, it is possible to preferably proceed the desired reaction and to form a chemisorbed film of the silane compound.

In a case of performing the hydrophobic treatment using the silane compound in a gaseous phase, the particles to be subjected to the hydrophobic treatment are exposed to vapor of the silane compound, and accordingly, it is possible to preferably proceed the desired reaction and to form a chemisorbed film of the silane compound.

An average particle diameter of the particles configuring the three-dimensional formation powders is not particularly limited, but is preferably from 1 μm to 25 μm and more preferably from 1 μm to 15 μm. Accordingly, it is possible to realize particularly excellent mechanical strength of the three-dimensional structure, to more effectively prevent generation of unexpected irregularities on the three-dimensional structure to be manufactured, and to realize particularly excellent dimensional accuracy of the three-dimensional structure. In addition, it is possible to realize particularly excellent fluidity of the three-dimensional formation powders and fluidity of the three-dimensional formation compositions (composition A and composition B) containing the three-dimensional formation powders and to realize particularly excellent productivity of the three-dimensional structure. In the invention, the average particle diameter means an average particle diameter based on a volume, and this can be acquired, for example, by an average particle diameter of a dispersion obtained by adding a sample to methanol and dispersing the sample with an ultrasonic dispersion device for 3 minutes, in a particle size distribution measuring device (TA-II manufactured by Coulter Electronics, Inc.) using an aperture having a diameter of 50 μm by a coulter counter method.

Dmax of the particles configuring the three-dimensional formation powders is preferably from 3 μm to 40 μm and more preferably from 5 μm to 30 μm. Accordingly, it is possible to realize particularly excellent mechanical strength of the three-dimensional structure, to more effectively prevent generation of unexpected irregularities on the three-dimensional structure to be manufactured, and to realize particularly excellent dimensional accuracy of the three-dimensional structure. In addition, it is possible to realize particularly excellent fluidity of the three-dimensional formation powders and fluidity of the three-dimensional formation compositions (composition A and composition B) containing the three-dimensional formation powders and to realize particularly excellent productivity of the three-dimensional structure. Further, it is possible to more effectively prevent scattering of light due to the particles on the surface of the three-dimensional structure to be manufactured.

When the particles are porous particles, a porosity of the porous particles is preferably equal to or greater than 50% and more preferably from 55% to 90%. Accordingly, a space (hole) for the binding agent to be introduced is sufficiently provided, and it is possible to realize excellent mechanical strength of the porous particles themselves. As a result, it is possible to realize particularly excellent mechanical strength of the three-dimensional structure formed by the binding resin permeating the inside of the hole. In the invention, the porosity of the particles means a ratio (volume ratio) of holes present inside of the particles to apparent volume of the particles, and is a value represented by {(ρ₀−ρ)/ρ₀}×100, when a density of the particles is set as ρ [g/cm³] and a true density of the constituent material of the particles is set as ρ₀ [g/cm³].

When the particles are porous particles, an average hole diameter (pore diameter) of the porous particles is preferably equal to or greater than 10 nm and is more preferably from 50 nm to 300 nm. Accordingly, it is possible to realize particularly excellent mechanical strength of the three-dimensional structure to be finally acquired. In addition, in a case of using a colored binding solution containing a pigment in manufacturing the three-dimensional structure, it is possible to preferably hold the pigment in the holes of the porous particles. Therefore, it is possible to prevent unexpected diffusion of the pigment and to more reliably form a high definition image.

The particles configuring the three-dimensional formation powders may have any shapes, but preferably have a spherical shape. Accordingly, it is possible to realize particularly excellent fluidity of the three-dimensional formation powders and fluidity of the three-dimensional formation compositions (composition A and composition B) containing the three-dimensional formation powders, to realize particularly excellent productivity of the three-dimensional structure, to more effectively prevent generation of unexpected irregularities on the three-dimensional structure to be manufactured, and to realize particularly excellent dimensional accuracy of the three-dimensional structure.

The three-dimensional formation powders may contain the plurality types of particles having different conditions described above (for example, types of constituent materials of the particles and the hydrophobic treatment) from each other.

A void ratio of the three-dimensional formation powders is preferably from 70% to 98% and more preferably from 75% to 97.7%. Accordingly, it is possible to realize particularly excellent mechanical strength of the three-dimensional structure. In addition, it is possible to realize particularly excellent fluidity of the three-dimensional formation powders and fluidity of the three-dimensional formation compositions (composition A and composition B) containing the three-dimensional formation powders, to realize particularly excellent productivity of the three-dimensional structure, to more effectively prevent generation of unexpected irregularities on the three-dimensional structure to be manufactured, and to realize particularly excellent dimensional accuracy of the three-dimensional structure. In the invention, the void ratio of the three-dimensional formation powders means a ratio of sum of a volume of voids included in all particles configuring the three-dimensional formation powders and a volume of voids present between the particles, to a capacity of a container, in a case where a container having predetermined capacity (for example, 100 mL) is filled with the three-dimensional formation powders, and is a value represented by {(P₀−P)/P₀}×100, when a bulk density of the particles is set as P [g/cm³] and a true density of the constituent material of the particles is set as P₀ [g/cm³].

A content rate of the three-dimensional formation powders in the three-dimensional formation compositions (composition A and composition B) is preferably from 10% by mass to 90% by mass and more preferably from 15% by mass to 58% by mass. Accordingly, it is possible to realize sufficiently excellent fluidity of the three-dimensional formation compositions (composition A and composition B) and to realize particularly excellent mechanical strength of the three-dimensional structure to be finally acquired.

### Water-Soluble Resin

The three-dimensional formation compositions (composition A and composition B) may contain the plurality of particles and the water-soluble resin. By containing the water-soluble resin, it is possible to bind (temporarily fix) the particles to each other and to effectively prevent unexpected scattering of the particles. Therefore, it is possible to realize safety of an operator and improvement of dimensional accuracy of the three-dimensional structure to be manufactured.

In the specification, an water-soluble resin may be used as long as a part thereof is soluble in water, but solubility with respect to water (mass soluble in 100 g of water) at 25° C. is, for example, preferably equal to or greater than 5 [g/100 g of water] and more preferably equal to or greater than 10 [g/100 g of water].

Examples of the water-soluble resin include a synthetic polymer such as polyvinyl alcohol (PVA), polyvinyl pyrrolidone (PVP), sodium polyacrylate, polyacrylamide, modified polyamide, polyethylene imine, or polyethylene oxide, a natural polymer such as corn starch, mannan, pectin, agar, alginic acid, dextran, glue, or gelatin, and a semisynthetic polymer such as carboxymethyl cellulose, hydroxyethyl cellulose, oxidized starch, or modified starch, and one kind or a combination of two or more kinds selected from these can be used.

Examples of the product of the water-soluble resin include methyl cellulose (product name “METOLOSE SM-15” manufactured by Shin-Etsu Chemical Co., Ltd.), hydroxyethyl cellulose (product name “AL-15” manufactured by FUJI Chemical Inc.), hydroxypropyl cellulose (product name “HPC-M” manufactured by Nippon Soda Co., Ltd.), Carboxymethyl cellulose (product name “CMC-30” manufactured by Nichirin Chemical Industries, Ltd.), sodium starch phosphate (I) (product name “Hoster 5100” manufactured by Matsutani Chemical Industry Co., Ltd.), polyvinylpyrrolidone (product name “PVP K-90” manufactured by Tokyo Chemical Co., LTd.), a methyl vinyl ether/maleic anhydride copolymer (product name “AN-139” manufactured by GAF Gauntlet), polyacrylamide (manufactured by Wako Pure Chemical Industries, Ltd.), modified polyamide (modified nylon) (“AQ nylon” manufactured by Toray Industries, Inc.), polyethylene oxide (product name “PEO-1” manufactured by Seitetsu Kagaku Kogyo K.K.), an ethylene oxide/propylene oxide random copolymer (product name “ALKOX EP” manufactured by Meisei Chemical Works, Ltd.), sodium polyacrylate (manufactured by Wako Pure Chemical Industries, Ltd.), and a carboxyvinyl polymer/crosslinked acrylic water-soluble resin (product name “AQUPEC” manufactured by Sumitomo Seika Chemicals Co., Ltd.)

Among these, when the water-soluble resin is polyvinyl alcohol, it is possible to realize particularly excellent mechanical strength of the three-dimensional structure. In addition, by adjusting a degree of saponification or a degree of polymerization, it is possible to more preferably control characteristics (for example, water solubility or water resistance) of the water-soluble resin or characteristics (for example, viscosity, fixing force of particles, or wettability) of the three-dimensional formation compositions (composition A and composition B). Therefore, it is possible to more preferably respond the manufacturing of various shapes of the three-dimensional structure. In addition, among the various water-soluble resins, polyvinyl alcohol is provided with a low cost and the supply thereof is stable. Thus, it is possible to perform stable manufacturing of the three-dimensional structure while keeping a production cost low.

When the water-soluble resin contains polyvinyl alcohol, a degree of saponification of the polyvinyl alcohol is preferably from 85 to 90. Accordingly, it is possible to prevent a decrease in solubility of polyvinyl alcohol with respect to water. Therefore, when the three-dimensional formation compositions (composition A and composition B) contain water, it is possible to more effectively prevent a decrease in adhesiveness between the unit layers 7 adjacent to each other.

When the water-soluble resin contains polyvinyl alcohol, a degree of polymerization of the polyvinyl alcohol is preferably from 300 to 1000. Accordingly, when the three-dimensional formation compositions (composition A and composition B) contain water, it is possible to realize particularly excellent mechanical strength of each unit layer 7 and adhesiveness between the unit layers 7 adjacent to each other.

When the water-soluble resin is polyvinyl pyrrolidone (PVP), the following effects are obtained. That is, since polyvinyl pyrrolidone has excellent adhesiveness with respect to various materials such as glass, metal, and plastic, it is possible to realize particularly excellent strength and stability of the shape of the portion of the layer 6 to which the binding solution is not applied, and to realize particularly excellent dimensional accuracy of the three-dimensional structure to be finally acquired. Since polyvinyl pyrrolidone has high solubility with respect to various organic solvents, when the three-dimensional formation compositions (composition A and composition B) contain an organic solvent, it is possible to realize particularly excellent fluidity of the three-dimensional formation compositions, to preferably form the layer 6 in which unexpected unevenness in the thickness is more effectively prevented, and to realize particularly excellent dimensional accuracy of the three-dimensional structure to be finally acquired. Since polyvinyl pyrrolidone has high solubility with respect to water, it is possible to easily and reliably remove the non-bound particles by the binding solution among the particles configuring each layer 6, in the removing step of the non-bound particles (after completing the formation). Since polyvinyl pyrrolidone has appropriate affinity with three-dimensional formation powders, the introduction thereof into the holes as described above does not sufficiently occur, but wettability with respect to the surface of the particle is comparatively high. Accordingly, it is possible to more effectively exhibit a function of temporarily fixing as described above. Since polyvinyl pyrrolidone has excellent affinity with various colorants, it is possible to effectively prevent unexpected diffusion of the colorant, in a case where a binding solution containing a colorant is used in the binding solution application step. In a case of using paste as the three-dimensional formation composition in the layer formation step, when the paste-like three-dimensional formation composition contains polyvinyl pyrrolidone, it is possible to effectively prevent bubbles generating in the three-dimensional formation composition and to more effectively prevent generation of defects due to bubbles in the layer formation step.

When the water-soluble resin contains polyvinyl pyrrolidone, a weight average molecular weight of the polyvinyl pyrrolidone is preferably from 10,000 to 1,700,000 and more preferably from 30,000 to 1,500,000. Accordingly, it is possible to more effectively exhibit the functions described above.

In the three-dimensional formation composition, the water-soluble resin is preferably formed in a liquid state (for example, a dissolved state or a melted state) at least in the layer formation step. Accordingly, it is possible to further increase uniformity in the thickness of the layer 6 formed using the three-dimensional formation composition.

A content rate of the water-soluble resin in the three-dimensional formation composition is preferably equal to or smaller than 15% by volume and more preferably from 2% by volume to 5% by volume, with respect to the true volume of the three-dimensional formation powder. Accordingly, it is possible to sufficiently exhibit the functions of the water-soluble resin described above, to ensure wider spaces for permeation of the binding solution, and to realize particularly excellent mechanical strength of the three-dimensional structure.

### Solvent

The three-dimensional formation compositions (composition A and composition B) may contain a solvent in addition to the water-soluble resin described above and the three-dimensional formation powders. Accordingly, it is possible to realize particularly excellent fluidity of the three-dimensional formation compositions and to realize particularly excellent productivity of the three-dimensional structure.

The solvent preferably dissolves the water-soluble resin. Accordingly, it is possible to realize excellent fluidity of the three-dimensional formation compositions and more effectively prevent unexpected unevenness in the thickness of the layer 6 formed using the three-dimensional formation compositions. In addition, when the layer 6 is formed in a state where the solvent is removed, it is possible to adhere the water-soluble resin to the particle with higher uniformity over the entire layer 6 and to more effectively prevent generation of unexpected non-uniformity in the composition. Therefore, it is possible to more effectively prevent unexpected variation in the mechanical strength of each portion of the three-dimensional structure to be finally acquired and to increase reliability of the three-dimensional structure.

Examples of the solvent configuring the three-dimensional formation compositions include water; an alcohol-based solvent such as methanol, ethanol, or isopropanol; a ketone-based solvent such as methylethyl ketone or acetone; a glycol ether-based solvent such as ethylene glycol monoethyl ether or ethylene glycol monobutyl ether; a glycol ether acetate-based solvent such as propylene glycol 1-monomethyl ether 2-acetate or propylene glycol 1-monomethyl ether 2-acetate; polyethylene glycol; and polypropylene glycol, and one kind or a combination of two or more kinds selected from these can be used.

Among these, the three-dimensional formation compositions preferably contain water. Accordingly, it is possible to more reliably dissolve the water-soluble resin and to realize particularly excellent fluidity of the three-dimensional formation compositions and uniformity of the composition of the layer 6 formed using the three-dimensional formation compositions. In addition, the water is easily removed after forming the layer 6, and a negative effect hardly occurs even when water remains in the three-dimensional structure. Further, the water is advantageous in viewpoints of safety for a human body and environmental problems.

When the three-dimensional formation compositions (composition A and composition B) contain the solvent, a content rate of the solvent in the three-dimensional formation compositions is preferably from 5% by mass to 75% by mass and more preferably from 35% by mass to 70% by mass. Accordingly, the effects obtained by containing the solvent as described above are more significantly exhibited and it is possible to easily remove the solvent in the manufacturing process of the three-dimensional structure in a short time, and therefore, it is advantageous in a viewpoint of improvement of the productivity of the three-dimensional structure.

Particularly, when the three-dimensional formation compositions contain water, a content rate of water in the three-dimensional formation compositions is preferably from 20% by mass to 73% by mass and more preferably from 50% by mass to 70% by mass. Accordingly, the effects described above are more significantly exhibited.

### Other Components

The three-dimensional formation compositions may further contain components other than the components described above. Examples of such components include a polymerization initiator; a polymerization promoter, a permeation promoter; a wetting agent (moisturizing agent); a fixing agent; an antifungal agent; a preservative; an antioxidant; an ultraviolet absorber; a chelating agent; and a pH adjuster.

### 4. Actual Body Formation Binding Solution

The actual body formation binding solution at least contains a binding agent (curing component).

### Binding Agent

Examples of the binding agent (curing component) include a thermosetting resin; various photo-curable resins such as a visible light curable resin (photo-curable resin in a narrow sense) which cures by light in a visible light region, an ultraviolet curable resin, and an infrared curable resin; and an X-ray curable resin, and one kind or a combination of two or more kinds selected from these can be used.

Among these, the ultraviolet curable resin (polymerizable compound) is particularly preferable in the viewpoints of the mechanical strength of the three-dimensional structure 1 to be obtained or the productivity of the three-dimensional structure 1 and storage stability of the actual body formation binding solution.

As the ultraviolet curable resin (polymerizable compound), it is preferable to use a resin in which addition polymerization or ring-opening polymerization is started by radical species or cationic species generated from a photoinitiator by ultraviolet ray irradiation and which generates a polymer. Examples of a polymerization method of the addition polymerization include radical, cationic, anionic, metathesis, and coordination polymerizations. In addition, Examples of a polymerization method of the ring-opening polymerization include cationic, anionic, radical, metathesis, and coordination polymerizations.

As an addition polymerizable compound, a compound having at least one ethylenically unsaturated double bond is used, for example. As the addition polymerizable compound, a compound having at least one and preferably two or more ethylenically unsaturated bond at the terminal can be preferably used.

The ethylenically unsaturated polymerizable compound has a chemical form of a monofunctional polymerizable compound and a polyfunctional polymerizable compound or a mixture thereof.

Examples of the monofunctional polymerizable compound include unsaturated carboxylic acid (for example, acrylic acid, methacrylic acid, itaconic acid, crotonic acid, isocrotonic acid, and maleic acid) or esters and amides thereof.

Examples of the polyfunctional polymerizable compound include ester of unsaturated carboxylic acid and an aliphatic polyalcohol compound and amides of unsaturated carboxylic acid and an aliphatic amine compound.

In addition, an addition reactant of unsaturated carboxylic acid ester or amides having a hydroxyl group or a nucleophilic substituent such as an amino group and a mercapto group, and isocyanates and epoxies, and a dehydration condensation reactant with carboxylic acid can also be used. Further, an addition reaction product of unsaturated carboxylic acid ester or amides having an electrophilic substituent such as an isocyanate group or an epoxy group, and alcohols, amines, and thiols, and a substitution reactant of unsaturated carboxylic acid ester or amides having an eliminating substituent such as a halogen group or a tosyloxy group, and alcohols, amines, and thiols can also be used.

As a specific example of a radical polymerizable compound which is ester of unsaturated carboxylic acid and aliphatic polyhydric alcohol, ester (meth)acrylate is representative, for example, and any of monofunctional or polyfunctional compound can be used.

Specific examples of the monofunctional (meth)acrylate include tolyl oxyethyl (meth)acrylate, phenyloxyethyl (meth)acrylate, cyclohexyl (meth)acrylate, ethyl (meth)acrylate, methyl (meth)acrylate, isobornyl (meth)acrylate, dipropylene glycol di(meth)acrylate, tetrahydrofurfuryl (meth)acrylate, ethoxyethoxyethyl (meth)acrylate, 2-(2-vinyloxyethoxy) ethyl (meth)acrylate, 2-hydroxy-3-phenoxypropyl (meth)acrylate, and 4-hydroxybutyl (meth)acrylate.

Specific examples of the bifunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexane diol di(meth)acrylate, tetraethylene glycol di(meth)acrylate, pentaerythritol di(meth)acrylate, and dipentaerythritol di(meth)acrylate.

Specific examples of the trifunctional (meth)acrylate include trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylol propane tri(meth)acrylate, and sorbitol tri(meth)acrylate.

Specific examples of the tetrafunctional (meth)acrylate include pentaerythritol tetra(meth)acrylate, sorbitol tetra(meth)acrylate, ditrimethylolpropane tetra(meth)acrylate, dipentaerythritol propionate tetra(meth)acrylate, and ethoxylated pentaerythritol tetra(meth)acrylate.

Specific examples of the pentafunctional (meth)acrylate include sorbitol penta(meth)acrylate and dipentaerythritol penta(meth)acrylate.

Specific examples of the hexafunctional (meth)acrylate include dipentaerythritol hexa(meth)acrylate, sorbitol hexa(meth)acrylate, alkylene oxide-modified hexa(meth)acrylate of phosphazene, and caprolactone-modified dipentaerythritol hexa(meth)acrylate.

Examples of the polymerizable compound other than (meth)acrylate include itaconic acid esters, crotonic acid esters, isocrotonic acid esters, and maleic acid esters.

Examples of itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate, abd sorbitol tetraitaconate.

Examples of crotonic acid ester include ethylene glycol dicrotonate, tetramethylene glycol dicrotonate, pentaerythritol dicrotonate, and sorbitol tetra-dicrotonate.

Examples of isocrotonic acid ester include ethylene glycol iso crotonate, pentaerythritol iso crotonate, and sorbitol tetraisocrotonate.

Examples of maleic acid ester include ethylene glycol dimaleate, triethylene glycol dimaleate, pentaerythritol dimaleate, and sorbitol tetra malate.

Examples of other ester include aliphatic alcohol-based esters disclosed in JP-B-46-27926, JP-B-51-47334, and JP-A-57-196231, a compound having an aromatic skeleton disclosed in JP-A-59-5240, JP-A-59-5241, and JP-A-2-226149, and a compound containing an amino group disclosed in JP-A-1-165613.

Specific examples of a monomer of amide of unsaturated carboxylic acid and an aliphatic amine compound include methylene bis-acrylamide, methylene bis-methacrylamide, 1,6-hexamethylene-bis-acrylamide, 1,6-hexamethylene-bis-methacrylamide, diethylenetriamine trisacrylamide, xylylene bisacrylamide, xylylene bismethacrylamide, and (meth)acryloyl morpholine.

Examples of other preferable amide-based monomer include a monomer having a cyclohexylene structure disclosed in JP-B-54-21726.

An urethane-based addition polymerizable compound manufactured using the addition reaction of isocyanate and a hydroxyl group is also preferable, and specific examples thereof include a vinyl urethane compound containing two or more polymerizable vinyl groups in one molecule obtained by adding a vinyl monomer containing a hydroxyl group represented by the following Formula (1) to a polyisocyanate compound including two or more isocyanate groups in one molecule disclosed in JP-B-48-41708.

CH₂═C(R¹)COOCH₂CH(R²)OH (1)

(Herein, in Formula (1), R¹ and R² each independently represent H or CH₃.)

In the invention, a cationic ring-opening polymerizable compound having one or more cyclic ether groups such as an epoxy group or an oxetane group in a molecule can be preferably used as the ultraviolet curable resin (polymerizable compound).

As the cationic polymerizable compound, for example, a thermosetting compound containing ring-opening polymerizable compounds is used, for example, and among these, a heterocyclic group-containing curable compound is particularly preferable. Examples of such a curable compound include cyclic imino ethers such as an epoxy derivative, an oxetane derivative, a tetrahydrofuran derivative, a cyclic lactone derivative, a cyclic carbonate derivative, or an oxazoline derivative, and vinyl ethers, and among these, an epoxy derivative, an oxetane derivative, and vinyl ethers are preferable.

Preferable examples of an epoxy derivative include monofunctional glycidyl ethers, polyfunctional glycidyl ethers, monofunctional alicyclic epoxides, and polyfunctional alicyclic epoxies.

Specific examples of compounds of glycidyl ethers include diglycidyl ethers (for example, ethylene glycol diglycidyl ether or bisphenol A diglycidyl ether), tri- or higher functional glycidyl ethers (for example, trimethylol ethane triglycidyl ether, trimethylolpropane triglycidyl ether, glycerol triglycidyl ether, or triglycidyl tris-hydroxyethyl isocyanurate), tetra- or higher glycidyl ethers (for example, sorbitol tetraglycidyl ether, pentaerythritol tetraglycidyl ether, polyglycidyl ether of a cresol novolac resin, or polyglycidyl ether of a phenol novolac resin), alicyclic epoxies (for example, CELLOXIDE 2021P, CELLOXIDE 2081, EPOLEAD GT-301, or EPOLEAD GT-401 (all manufactured by Daicel Corporation), EHPE (manufactured by Daicel Corporation), or polycyclohexyl epoxy methyl ethers of a phenol novolac resin), and oxetanes (for example, OX-SQ or PNOX-1009 (all manufactured by Toagosei Company, Limited.)

As the polymerizable compound, an alicyclic epoxy derivative can be preferably used. The “alicyclic epoxy group” is a substructure obtained by epoxidizing a double bond of a cycloalkene ring such as a cyclopentene group or a cyclohexene group by a suitable oxidant such as hydrogen peroxide or peracetic acid.

As the alicyclic epoxy compound, a polyfunctional alicyclic epoxies having two or more cyclohexene oxide groups or cyclopentene oxide groups in one molecule are preferable. Specific examples of the alicyclic epoxy compound include 4-vinyl cyclohexene dioxide, (3,4-epoxy cyclohexyl) methyl-3,4-epoxy cyclohexyl carboxylate, di(3,4-epoxy cyclohexyl) adipate, di(3,4-epoxycyclohexylmethyl) adipate, bis(2,3-epoxy cyclopentyl) ether, di(2,3-epoxy-6-methylcyclohexylmethyl) adipate, and dicyclopentadiene oxide.

A general glycidyl compound having an epoxy group and not having an alicyclic structure in a molecule can be used alone or can be used with the alicyclic epoxy compound described above.

As a general glycidyl compound, a glycidyl ether compound or a glycidyl ester compound can be used, for example, and it is preferable to use with a glycidyl ether compound.

Specific examples of the glycidyl ether compound include an aromatic glycidyl ether compound such as 1,3-bis(2,3-epoxypropyloxy)benzene, a bisphenol A type epoxy resin, a bisphenol F type epoxy resin, a phenol.novolac type epoxy resin, a cresol.novolac type epoxy resin, or trisphenolmethane type epoxy resin, and an aliphatic glycidyl ether compound such as 1,4-butanediol glycidyl ether, glycerol triglycidyl ether, propylene glycol diglycidyl ether, or trimethylolpropane triglycidyl ether. Examples of glycidyl ester include glycidyl ester of a linoleic acid dimer.

As the polymerizable compound, a compound having an oxetanyl group which is a four-membered cyclic ether (hereinafter, also simply referred to as an “oxetane compound”) can be used. The oxetanyl-group containing compound is a compound having one or more oxetanyl groups in one molecule.

Among the curing components described above, one kind or a component containing two or more kinds selected from a group consisting of 2-(2-vinyloxyethoxy) ethyl (meth)acrylate, a polyether-based aliphatic urethane (meth)acrylate oligomer, 2-hydroxy-3-phenoxypropyl (meth)acrylate, and 4-hydroxybutyl (meth)acrylate is particularly preferable as the actual body formation binding solution. Accordingly, it is possible to cure the actual body formation binding solution at a more suitable curing rate, and it is possible to realize particularly excellent productivity of the three-dimensional structure 1.

In addition, it is possible to realize particularly excellent strength, durability, and reliability of the three-dimensional structure 1.

By containing these curing components, it is possible to particularly decrease solubility of the cured material of the actual body formation binding solution with respect to various solvents (for example, water or the like) and a swelling property thereof. As a result, in the sacrificial layer removing step, it is possible to more reliably remove the sacrificial layer 8 with high selectivity and to prevent unexpected deformation due to defects generated in the three-dimensional structure 1. Therefore, it is possible to more reliably increase dimensional accuracy of the three-dimensional structure 1.

Since it is possible to decrease the swelling property (absorbability of solvent) of the cured material of the actual body formation binding solution, it is possible to omit or simplify a drying process as the post-treatment of the sacrificial layer removing step, for example. In addition, solvent resistance of the three-dimensional structure 1 to be finally acquired is also increased, and therefore, it is possible to particularly increase reliability of the three-dimensional structure 1.

Particularly, when the actual body formation binding solution contains 2-(2-vinyloxyethoxy) ethyl (meth)acrylate, it is possible to perform curing with a low energy without oxygen inhibition, the copolymerization containing other monomers is promoted, and the strength of the structure is increased.

When the actual body formation binding solution contains a polyether-based aliphatic urethane (meth)acrylate oligomer, both of high strength and high toughness of the structure are realized.

When the actual body formation binding solution contains 2-hydroxy-3-phenoxypropyl (meth)acrylate, flexibility is obtained and a breaking elongation is improved.

When the actual body formation binding solution contains 4-hydroxybutyl (meth)acrylate, adhesiveness to PMMA and PEMA particles, silica particles, or metal particles is improved, and accordingly, the strength of the structure is increased.

When the actual body formation binding solution contains the specific curing component described above (one kind or a combination of two or more kinds selected from a group consisting of 2-(2-vinyloxyethoxy) ethyl (meth)acrylate, a polyether-based aliphatic urethane (meth)acrylate oligomer, 2-hydroxy-3-phenoxypropyl (meth)acrylate, and 4-hydroxybutyl (meth)acrylate), a rate of the specific ruing component with respect to the entire curing component configuring the actual body formation binding solution is preferably equal to or greater than 80% by mass, more preferably equal to or greater than 90% by mass, and even more preferably 100% by mass. Accordingly, the effects described above are more significantly exhibited.

A content rate of the curing component in the actual body formation binding solution is preferably from 80% by mass to 97% by mass and more preferably from 85% by mass to 95% by mass.

Accordingly, it is possible to realize particularly excellent mechanical strength of the three-dimensional structure 1 to be finally acquired. In addition, it is possible to realize particularly excellent productivity of the three-dimensional structure 1.

When a refractive index of the particles 63 configuring the three-dimensional formation powders is set as n1 and a refractive index of the cured material of the curable resin contained in the actual body formation binding solution is set as n2, it is preferable to satisfy a relationship of |n1−n2|≦0.2 and it is more preferable to satisfy a relationship of |n1−n2|≦0.1. Accordingly, it is possible to more effectively prevent scattering of light on the outer surface of the three-dimensional structure 1 to be manufactured. As a result, it is possible to perform clear color reproduction.

### Polymerization Initiator

The actual body formation binding solution preferably contains a polymerization initiator.

Accordingly, it is possible to increase the curing rate of the actual body formation binding solution when manufacturing the three-dimensional structure 1 and to realize particularly excellent productivity of the three-dimensional structure 1.

Examples of the polymerization initiator include a photoradical polymerization initiator (aromatic ketones, an acyl phosphine oxide compound, an aromatic onium salt compound, an organic peroxide, a thio compound (a thioxanthone compound or a thiophenyl group-containing compound), a hexaarylbiimidazole compound, a ketoxime ester compound, a borate compound, an azinium compound, a metallocene compound, an active ester compound, a compound having a carbon halogen bond, or an alkyl amine compound) or a photocationic polymerization initiator, and specific examples thereof include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chloro benzophenone, 4,4′-dimethoxy benzophenone, 4,4′-diamino benzophenone, Michler's ketone, benzoin propyl ether, benzoin ethyl ether, benzyl dimethyl ketal, 1-(4-isopropyl-phenyl)-2-hydroxy-2-methylpropane-1-one, 2-hydroxy-2-methyl-1-phenylpropane-1-one, thioxanthone, diethyl thioxanthone, 2-isopropyl thioxanthone, 2-chloro thioxanthone, 2-methyl-1-[4-(methylthio) phenyl]-2-morpholino-propane-1-one, bis(2,4,6-trimethyl benzoyl)-phenyl phosphine oxide, 2,4,6-trimethyl benzoyl-diphenyl-phosphine oxide, 2,4-diethyl thioxanthone, and bis-(2,6-dimethoxy-benzoyl) 2,4,4-trimethyl pentyl phosphine oxide, and one kind or a combination of two or more kinds selected from these can be used.

Among these, as the polymerization initiator configuring the actual body formation binding solution, it is preferable to contain bis(2,4,6-trimethyl benzoyl)-phenyl phosphine oxide and 2,4,6-trimethyl benzoyl-diphenyl-phosphine oxide.

By containing such a polymerization initiator, it is possible to cure the actual body formation binding solution at a more suitable curing rate and to realize particularly excellent productivity of the three-dimensional structure 1. In addition, it is possible to realize particularly excellent strength, durability, and reliability of the three-dimensional structure 1.

Particularly, when the actual body formation binding solution contains bis(2,4,6-trimethyl benzoyl)-phenyl phosphine oxide as a polymerization initiator, along with the sacrificial layer formation binding solution which will be described later, it is possible to more preferably perform the control of the curing rate regarding the actual body formation binding solution and the sacrificial layer formation binding solution and to realize more excellent productivity of the three-dimensional structure 1.

When the actual body formation binding solution contains bis(2,4,6-trimethyl benzoyl)-phenyl phosphine oxide as a polymerization initiator, along with the sacrificial layer formation binding solution which will be described later, a content rate of bis(2,4,6-trimethyl benzoyl)-phenyl phosphine oxide in the actual body formation binding solution is preferably higher than a content rate of bis(2,4,6-trimethyl benzoyl)-phenyl phosphine oxide in the sacrificial layer formation binding solution.

Accordingly, it is possible to cure each of the actual body formation binding solution and the sacrificial layer formation binding solution at a more preferable rate.

The content rate of the polymerization initiator in the actual body formation binding solution is not particularly limited, but it is preferable to be higher than the content rate of the polymerization initiator in the sacrificial layer formation binding solution.

Therefore, it is possible to cure each of the actual body formation binding solution and the sacrificial layer formation binding solution at a more preferable rate.

For example, by adjusting the processing conditions of the curing step, it is possible to sufficiently increase a degree of curing of the three-dimensional structure 1 and to comparatively decrease a degree of polymerization of the sacrificial layer 8, after the completing the curing step. As a result, it is possible to more easily remove the sacrificial layer 8 in the sacrificial layer removing step and to realize particularly excellent productivity of the three-dimensional structure 1.

Since it is not necessary to increase an amount of an energy beam to be emitted, more than necessary, it is preferable in a viewpoint of energy saving.

Particularly, when the content rate of the polymerization initiator in the actual body formation binding solution is set as X₁ [% by mass] and the content rate of the polymerization initiator in the sacrificial layer formation binding solution set as X₂ [% by mass], it is preferable to satisfy a relationship of 1.05 X₁/X₂≦2.0 and it is more preferable to satisfy a relationship of 1.1≦X₁/X₂≦1.5.

Accordingly, it is possible to cure each of the actual body formation binding solution and the sacrificial layer formation binding solution at a more preferable rate and to realize particularly excellent productivity of the three-dimensional structure 1.

A specific value of the content rate of the polymerization initiator in the actual body formation binding solution is preferably from 3.0% by mass to 18% by mass and more preferably from 5.0% by mass to 15% by mass. Accordingly, it is possible to cure the actual body formation binding solution at a more suitable curing rate and to realize particularly excellent productivity of the three-dimensional structure 1. In addition, it is possible to realize particularly excellent mechanical strength and stability of the shape of the three-dimensional structure (actual body) 1 formed by curing the actual body formation binding solution. As a result, it is possible to realize particularly excellent strength, durability, and reliability of the three-dimensional structure 1.

Preferable specific examples of a combination ratio of the curable resin and the polymerization initiator in the actual body formation binding solution (an ink composition excluding “other components” described below) will be shown hereinafter, but the composition of the actual body formation binding solution of the invention is not limited to the followings.

### COMBINATION RATIO EXAMPLE

2-(2-vinyloxyethoxy) ethyl acrylate: 32 parts by mass
Polyether-based aliphatic urethane acrylate oligomer: 10 parts by mass
2-hydroxy-3-phenoxypropyl acrylate: 13.75 parts by mass
Dipropylene glycol diacrylate: 15 parts by mass
4-hydroxybutyl acrylate: 20 parts by mass
bis(2,4,6-trimethyl benzoyl)-phenyl phosphine oxide: 5 parts by mass
2,4,6-trimethyl benzoyl-diphenyl-phosphine oxide: 4 parts by mass

In a case of the combination described above, the effects described above are more significantly exhibited.

### Other Components

The actual body formation binding solution may further contain components other than the components described above.

Examples of such components include various colorants such as a pigment or dye; a dispersant; a surfactant; a sensitizer; a polymerization promoter; a solvent; a permeation promoter; a wetting agent (moisturizing agent); a fixing agent; an antifungal agent; a preservative; an antioxidant; an ultraviolet absorber; a chelating agent; a pH adjuster; a thickener; a filler; an aggregation prevention agent; and an antifoaming agent.

Particularly, when the actual body formation binding solution contains a colorant, it is possible to obtain the three-dimensional structure 1 colored in a color corresponding to the color of the colorant.

Particularly, by containing a pigment as a colorant, it is possible to realize excellent light resistance of the actual body formation binding solution and the three-dimensional structure 1. As a pigment, any one of an inorganic pigment and an organic pigment can be used.

Examples of the inorganic pigment include carbon blacks (C.I. Pigment Black 7) such as furnace black, lamp black, acetylene black, or channel black, iron oxide, and titanium oxide, and one kind or a combination of two or more kinds selected from these can be used.

Among the inorganic pigments, titanium oxide is preferable, in order to realize a preferable white color.

Examples of the organic pigment include an azo pigment such as an insoluble azo pigment, a condensed azo pigment, azo lake, or a chelate azo pigment, a polycyclic pigment such as a phthalocyanine pigment, a perylene and perinone pigment, an anthraquinone pigment, a quinacridone pigment, a dioxane pigment, a thioindigo pigment, an isoindolinone pigment, or a quinophthalone pigment, dye chelates (for example, base dye chelates or acidic dye chelates), dye lake (basic dye lake or acidic dye lake), a nitro pigment, a nitroso pigment, aniline black, and a daylight fluorescent pigment, and one kind or a combination of two or more kinds selected from these can be used.

Specifically, examples of carbon black used as a black pigment include No. 2300, No. 900, MCF88, No. 33, No. 40, No. 45, No. 52, MA7, MA8, MA100, No. 2200B (all manufactured by Mitsubishi Chemical Corporation), Raven 5750, Raven 5250, Raven 5000, Raven 3500, Raven 1255, Raven 700 (all manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, Monarch 1400 (all manufactured by CABOT JAPAN K.K.), Color Black FW1, Color Black FW2, Color Black FW2V, Color Black FW18, Color Black FW200, Color Black S150, Color Black 5160, Color Black 5170, Printex 35, Printex U, Printex V, Printex 140U, Special Black 6, Special Black 5, Special Black 4A, and Special Black 4 (all manufactured by Degussa).

Examples of a white pigment include C.I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, or C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of other pigments include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

When the actual body formation binding solution contains the pigments, an average particle diameter of the pigments is preferably equal to or smaller than 300 nm and more preferably from 50 nm to 250 nm.

Accordingly, it is possible to realize particularly excellent discharge stability of the actual body formation binding solution and dispersion stability of the pigments in the actual body formation binding solution and to form an image having more excellent image quality.

Examples of a dye include an acid dyes, a direct dye, a reactive dye, and a basic dye, and one kind or a combination of two or more kinds selected from these can be used.

Specific example of the dye include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

When the actual body formation binding solution contains the colorant, a content rate of the colorant in the actual body formation binding solution is preferably from 1% by mass to 20% by mass. Accordingly, particularly excellent concealing properties and color reproducibility are obtained.

Particularly, when the actual body formation binding solution contains titanium oxide as the colorant, a content rate of the titanium oxide in the actual body formation binding solution is preferably from 12% by mass to 18% by mass and more preferably from 14% by mass to 16% by mass. Accordingly, particularly excellent concealing properties are obtained.

When the actual body formation binding solution contains a pigment and a dispersant, it is possible to realize more excellent dispersibility of the pigment.

The dispersant is not particularly limited, but a dispersant commonly used for manufacturing a pigment dispersion such as a polymer dispersant is used, for example.

Specific examples of the polymer dispersant include materials having one or more kinds of polyoxyalkylene polyalkylene polyamine, vinyl-based polymer and copolymer, acrylic polymer and copolymer, polyester, polyamide, polyimide, polyurethane, an amino-based polymer, a silicon-containing polymer, a sulfur-containing polymer, a fluorine-containing polymer, and an epoxy resin, as a main component.

Examples of a commercially available product of the polymer dispersant include AJISPER series manufactured by Ajinomoto Fine-Techno Co., Inc., Solsperse series (Solsperse 36000 or the like) available from Noveon Inc., DISPERBYK series manufactured by BYK Japan K.K., and DISPARLON series manufactured by Kusumoto Chemicals, Ltd.

When the actual body formation binding solution contains a surfactant, it is possible to realize more excellent abrasion resistance of the three-dimensional structure 1.

The surfactant is not particularly limited, and for example, polyester-modified silicone or ether-modified silicone as a silicone-based surfactant can be used, and among these, polyether-modified polydimethylsiloxane or polyester-modified polydimethylsiloxane is preferably used.

Specific examples of the surfactant include BYK-347, BYK-348, BYK-UV3500, 3510, 3530, and 3570 (product names all manufactured by BYK Japan K. K.)

The actual body formation binding solution may contain a solvent.

Accordingly, it is possible to preferably perform adjustment of the viscosity of the actual body formation binding solution, and even when the actual body formation binding solution contains a component having high viscosity, it is possible to realize particularly excellent discharge stability of the actual body formation binding solution by an ink jet method.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetates such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; and alcohols such as ethanol, propanol, and butanol, and one kind or a combination of two or more kinds selected from these can be used.

A viscosity of the actual body formation binding solution is preferably from 10 mPa·s to 30 mPa·s and more preferably from 15 mPa·s to 25 mPa·s.

Accordingly, it is possible to realize particularly excellent discharge stability of the actual body formation binding solution by an ink jet method. In the specification, the viscosity is a value measured at 25° C. using an E-type viscometer (VISCONIC ELD manufactured by TOKYO KEIKI INC.)

In addition, various kinds of the actual body formation binding solution may be used in the manufacturing of the three-dimensional structure 1.

For example, the actual body formation binding solution containing a colorant (color ink) and the actual body formation binding solution not containing a colorant (clear ink) may be used together.

Accordingly, it is possible to use the actual body formation binding solution containing a colorant as an actual body formation binding solution to be applied to an area which affects the tone of color of the appearance of the three-dimensional structure 1 and to use actual body formation binding solution not containing a colorant as an actual body formation binding solution to be applied to an area which does not affect the tone of color of the appearance of the three-dimensional structure 1, and therefore, it is advantageous in a viewpoint of a decrease in production cost of the three-dimensional structure 1.

It is possible to use the plurality of kinds of the actual body formation binding solutions, so as to provide an area (coated layer) formed using the actual body formation binding solution not containing a colorant on an outer surface of an area formed using the actual body formation binding solution containing a colorant in the three-dimensional structure 1 to be finally acquired.

The portion containing a colorant (particularly, a pigment) is brittle, and scratches or cracks are easily generated, compared to the portion not containing a colorant. However, by providing the area (coated layer) formed by the actual body formation binding solution not containing a colorant, it is possible to effectively prevent generation of such a problem. In addition, even when the surface of the three-dimensional structure 1 is abrade due to a long time of use, it is possible to effectively prevent and suppress a change of the tone of color of the three-dimensional structure 1.

For example, the plurality of kinds of the actual body formation binding solutions containing colorants having different compositions from each other may be used.

Accordingly, it is possible to widen a color reproduction area which can be expressed by combining the actual body formation binding solutions.

In a case of using the plurality of kinds of the actual body formation binding solutions, at least, it is preferable to use a cyan actual body formation binding solution, a magenta actual body formation binding solution, and a yellow actual body formation binding solution.

Accordingly, it is possible to more widen the color reproduction area which can be expressed by combining the actual body formation binding solutions.

In addition, by using a white actual body formation binding solution and another colored actual body formation binding solution together, the following effects are obtained, for example.

That is, the three-dimensional structure 1 to be finally acquired can include a first area to which the white actual body formation binding solution is applied, and an area (second area) which is provided on an outer surface side with respect to the first area and to which a colored actual body formation binding solution, other than white, is applied. Accordingly, the first area to which the white actual body formation binding solution is applied, can exhibit concealing properties, and it is possible to more increase a chroma of the three-dimensional structure 1.

### 5. Sacrificial Layer Formation Binding Solution

The sacrificial layer formation binding solution at least contains a curable resin (curing component).

### Curable Resin

As the curable resin (curing component) configuring the sacrificial layer formation binding solution, a curable resin same as the curable resin (curing component) exemplified as the constituent component of the actual body formation binding solution is used, for example.

Particularly, the curable resin (curing component) configuring the sacrificial layer formation binding solution and the curable resin (curing component) configuring the actual body formation binding solution are preferably cured with the same kind of the energy beam.

Accordingly, it is possible to effectively prevent complicated configuration of the three-dimensional structure manufacturing apparatus and to realize particularly excellent productivity of the three-dimensional structure 1. In addition, it is possible to more reliably control a surface shape of the three-dimensional structure 1.

It is preferable to use a curing component to cause a cured material of the sacrificial layer formation binding solution to have hydrophilicity. Accordingly, it is possible to easily remove the sacrificial layer 8 by a solvent configured with aqueous liquid such as water.

Among various curing components, the sacrificial layer formation binding solution particularly preferably contains one kind or a combination of two or more kinds selected from a group consisting of tetrahydrofurfuryl (meth)acrylate, ethoxyethoxyethyl (meth)acrylate, polyethylene glycol di(meth)acrylate, and (meth)acryloyl morpholine, and 2-(2-vinyloxyethoxy) ethyl (meth)acrylate.

Accordingly, it is possible to cure the sacrificial layer formation binding solution at a more suitable curing rate and to realize particularly excellent productivity of the three-dimensional structure 1. In addition, it is possible to realize more preferable hydrophilicity of the cured material and to easily remove the sacrificial layer 8.

Further, it is possible to realize particularly excellent mechanical strength and stability of the shape of the sacrificial layer 8 formed by curing the sacrificial layer formation binding solution. As a result, when manufacturing the three-dimensional structure 1, the sacrificial layer 8 as a lower layer (first layer) can more preferably support the actual body formation binding solution for forming an upper layer (second layer). Therefore, it is possible to more preferably prevent unexpected deformation (particularly, sagging or the like) of the three-dimensional structure 1 (the sacrificial layer 8 as the first layer functions as a support material), and it is possible to realize more excellent dimensional accuracy of the three-dimensional structure 1 to be finally acquired.

Particularly, when the sacrificial layer formation binding solution contains (meth)acryloyl morpholine, the following effects are obtained.

That is, (meth)acryloyl morpholine has high solubility with respect to various solvents such as water in a state not completely cured (polymer of (meth)acryloyl morpholine in a state not completely cured), even when a curing reaction has proceeded. Accordingly, in the sacrificial layer removing step described above, it is possible to more effectively prevent generation of defects in the three-dimensional structure 1 and to selectively, reliably and effectively remove the sacrificial layer 8. As a result, it is possible to realize excellent productivity of the three-dimensional structure 1 formed in a desired shape.

When the sacrificial layer formation binding solution contains tetrahydrofurfuryl (meth)acrylate, flexibility is maintained after the curing, and the sacrificial layer formation binding solution is easily changed into a gel state by treatment with liquid for removing the sacrificial layer 8, and accordingly, removing properties are increased.

When the sacrificial layer formation binding solution contains ethoxyethoxyethyl (meth)acrylate, stickiness easily remains even after the curing, and removing properties with liquid for removing the sacrificial layer 8 are increased.

When the sacrificial layer formation binding solution contains polyethylene glycol di(meth)acrylate, solubility with respect to liquid is increased and the sacrificial layer is easily removed, when liquid for removing the sacrificial layer 8 contains water as a main component.

When the sacrificial layer formation binding solution contains the specific curing component described above (one kind or a combination of two or more kinds selected from a group consisting of tetrahydrofurfuryl (meth)acrylate, ethoxyethoxyethyl (meth)acrylate, polyethylene glycol di(meth)acrylate, and (meth)acryloyl morpholine), a rate of the specific curing component with respect to the entire curing component configuring the sacrificial layer formation binding solution is preferably equal to or greater than 80% by mass, more preferably equal to or greater than 90% by mass, and even more preferably 100% by mass. Accordingly, the effects described above are more significantly exhibited.

A content rate of the curing component in the sacrificial layer formation binding solution is preferably from 83% by mass to 98.5% by mass and more preferably from 87% by mass to 95.4% by mass.

Accordingly, it is possible to realize particularly excellent stability of the shape of the sacrificial layer 8 to be formed, and when the unit layers 7 are superposed when manufacturing the three-dimensional structure 1, it is possible to more effectively prevent unexpected deformation of the unit layer 7 on a lower side, and it is possible to preferably support the unit layer 7 on an upper side. As a result, it is possible to realize particularly excellent dimensional accuracy of the three-dimensional structure 1 to be finally acquired. In addition, it is possible to realize particularly excellent productivity of the three-dimensional structure 1.

### Polymerization Initiator

The sacrificial layer formation binding solution preferably contains a polymerization initiator.

Accordingly, it is possible to suitably increase the curing rate of the sacrificial layer formation binding solution when manufacturing the three-dimensional structure 1 and to realize particularly excellent productivity of the three-dimensional structure 1.

In addition, it is possible to realize particularly excellent stability of the shape of the sacrificial layer 8 to be formed, and when the unit layers 7 are superposed when manufacturing the three-dimensional structure 1, it is possible to more effectively prevent unexpected deformation of the unit layer 7 on a lower side, and it is possible to preferably support the unit layer 7 on an upper side. As a result, it is possible to realize particularly excellent dimensional accuracy of the three-dimensional structure 1 to be finally acquired.

As a polymerization initiator configuring the sacrificial layer formation binding solution, a polymerization initiator same as the polymerization initiator exemplified as the constituent component of the actual body formation binding solution is used, for example.

Among these, the sacrificial layer formation binding solution preferably contains bis(2,4,6-trimethyl benzoyl)-phenyl phosphine oxide and 2,4,6-trimethyl benzoyl-diphenyl-phosphine oxide, as the polymerization initiators.

By containing such polymerization initiators, it is possible to cure the sacrificial layer formation binding solution at a more suitable curing rate and to realize particularly excellent productivity of the three-dimensional structure 1.

In addition, it is possible to realize particularly excellent mechanical strength and stability of the shape of the sacrificial layer 8 formed by curing the sacrificial layer formation binding solution. As a result, when manufacturing the three-dimensional structure 1, the sacrificial layer 8 as a lower layer (first layer) can more preferably support the actual body formation binding solution for forming an upper layer (second layer). Therefore, it is possible to more preferably prevent unexpected deformation (particularly, sagging or the like) of the three-dimensional structure 1 (the sacrificial layer 8 as the first layer functions as a support material), and it is possible to realize more excellent dimensional accuracy of the three-dimensional structure 1 to be finally acquired.

A specific value of the content rate of the polymerization initiator in the sacrificial layer formation binding solution is preferably from 1.5% by mass to 17% by mass and more preferably from 4.6% by mass to 13% by mass.

Accordingly, it is possible to cure the sacrificial layer formation binding solution at a more suitable curing rate and to realize particularly excellent productivity of the three-dimensional structure 1.

In addition, it is possible to realize particularly excellent mechanical strength and stability of the shape of the sacrificial layer 8 formed by curing the sacrificial layer formation binding solution. As a result, when manufacturing the three-dimensional structure 1, the sacrificial layer 8 as a lower layer (first layer) can more preferably support the actual body formation binding solution for forming an upper layer (second layer). Therefore, it is possible to more preferably prevent unexpected deformation (particularly, sagging or the like) of the three-dimensional structure 1 (the sacrificial layer 8 as the first layer functions as a support material), and it is possible to realize more excellent dimensional accuracy of the three-dimensional structure 1 to be finally acquired.

Preferable specific examples of a combination ratio of the curable resin and the polymerization initiator in the sacrificial layer formation binding solution (an ink composition excluding “other components” described below) will be shown hereinafter, but the composition of the sacrificial layer formation ink of the invention is not limited to the followings.

### Combination Ratio Example 1

Tetrahydrofurfuryl acrylate: 36 parts by mass
Ethoxyethoxyethyl acrylate: 55.75 parts by mass
Bis(2,4,6-trimethyl benzoyl)-phenyl phosphine oxide: 3 parts by mass
2,4,6-trimethyl benzoyl-diphenyl-phosphine oxide: 5 parts by mass

### Combination Ratio Example 2

Dipropylene glycol diacrylate: 37 parts by mass
Polyethylene glycol (400) diacrylate: 55.85 parts by mass
Bis(2,4,6-trimethyl benzoyl)-phenyl phosphine oxide: 3 parts by mass
2,4,6-trimethyl benzoyl-diphenyl-phosphine oxide: 4 parts by mass

### Combination Ratio Example 3

Tetrahydrofurfuryl acrylate: 36 parts by mass
Acryloyl morpholine: 55.75 parts by mass
Bis(2,4,6-trimethyl benzoyl)-phenyl phosphine oxide: 3 parts by mass
2,4,6-trimethyl benzoyl-diphenyl-phosphine oxide: 5 parts by mass

### Combination Ratio Example 4

2-(2-vinyloxyethoxy) ethyl acrylate: 36 parts by mass
Polyethylene glycol (400) diacrylate: 55.75 parts by mass
Bis(2,4,6-trimethyl benzoyl)-phenyl phosphine oxide: 3 parts by mass
2,4,6-trimethyl benzoyl-diphenyl-phosphine oxide: 5 parts by mass

In a case of the combination described above, the effects described above are more significantly exhibited.

### Other Components

The sacrificial layer formation binding solution may further contain components other than the components described above. Examples of such components include various colorants such as a pigment or dye; a dispersant; a surfactant; a sensitizer; a polymerization promoter; a solvent; a permeation promoter; a wetting agent (moisturizing agent); a fixing agent; an antifungal agent; a preservative; an antioxidant; an ultraviolet absorber; a chelating agent; a pH adjuster; a thickener; a filler; an aggregation prevention agent; and an antifoaming agent.

Particularly, when the sacrificial layer formation binding solution contains a colorant, visibility of the sacrificial layer 8 is improved, and it is possible to more reliably prevent at least a part of the sacrificial layer 8 unexpectedly remaining in the three-dimensional structure 1 to be finally acquired.

As the colorant configuring the sacrificial layer formation binding solution, a colorant same as the colorant exemplified as the constituent component of the actual body formation binding solution is used, for example. However, it is preferable to use a colorant having a color different from a color to be visible in appearance of the three-dimensional structure 1 superposed with the sacrificial layer 8 formed with the sacrificial layer formation binding solution, when observed from a normal direction of the surface of the three-dimensional structure 1. Accordingly, the effects described above are more significantly exhibited.

When the sacrificial layer formation binding solution contains a pigment and a dispersant, it is possible to realize more excellent dispersibility of the pigment. As the dispersant configuring the sacrificial layer formation binding solution, a dispersant same as the dispersant exemplified as the constituent component of the actual body formation binding solution is used, for example.

A viscosity of the sacrificial layer formation binding solution is preferably from 10 mPa·s to 30 mPa·s and more preferably from 15 mPa·s to 25 mPa·s.

Accordingly, it is possible to realize particularly excellent discharge stability of the sacrificial layer formation binding solution by an ink jet method.

In addition, various kinds of the sacrificial layer formation binding solutions may be used in the manufacturing of the three-dimensional structure 1.

For example, two or more kinds of sacrificial layer formation binding solutions having different dynamic viscoelasticities when curing the actual body formation binding solution may be included.

Accordingly, it is possible to cause the three-dimensional structure 1 to be finally acquired to include a plurality of areas having different degrees of fine sense of texture. As a result, it is possible to express more complicated appearance and to realize particularly excellent aesthetic appearance (esthetics) and high-grade sensation of the three-dimensional structure 1.

Hereinabove, the preferred embodiments of the invention have been described, but the invention is not limited thereto.

For example, in the embodiments described above, the configuration of separately providing the collection unit and formation unit has been described, but there is no limitation, and the collection unit and formation unit may be integrally configured. In this case, the layer 6 may be formed by moving the collection unit and formation unit, without moving the squeegee.

In addition, in the manufacturing method of the invention, a pretreatment step, an intermediate treatment step, and a post-treatment step may be performed, if necessary.

As the pretreatment step, a cleaning step of the formation stage is used, for example.

Examples of the post-treatment step include a washing step, a shape adjustment step of performing deburring or the like, a coloring step, a coated layer formation step, and a curable resin curing completion step of performing a light irradiation process or a heating process for reliably curing the uncured curable resin.

In the embodiments described above, the case of performing the discharge step by an ink jet method has been mainly described, but the discharge step may be performed using other methods (for example, other printing methods).

In the embodiments described above, the sacrificial layer formation has been described, but the sacrificial layer may not be formed. For example, when forming the layer 6, an area for binding the three-dimensional formation powders may be formed with the composition A and the other areas may be formed with the composition B, by curing the discharged binding solutions, and the sacrificial layer may not be formed.

The layer 6 initially formed on the surface of the formation stage 102 may be formed with the composition B or a mixture of the composition A and the composition B. It is possible to efficiently reuse the composition B, and it is also possible to easily extract the three-dimensional structure 1 from the formation stage 102.

The composition A and the composition B may be appropriately used depending on the thickness of the layer 6. It is possible to efficiently reuse the composition B by using the composition B in a case of a great thickness of the layer 6 and using the composition A in a case of a small thickness (equal to or smaller than 150 μm) of the layer 6.

The entire disclosure of Japanese Patent Application No. 2014-048527, filed Mar. 12, 2014 is expressly incorporated by reference herein.

What is claimed is:

1. A manufacturing method of a three-dimensional structure which manufactures a three-dimensional structure by laminating layers, the method comprising:
forming the layers using a composition A containing three-dimensional formation powders and a solvent;
discharging a binding solution for binding the three-dimensional formation powders to the layers;
binding the three-dimensional formation powders by curing the discharged binding solution;
removing the non-bound three-dimensional formation powders using the solvent; and
additionally adding the three-dimensional formation powders to a mixed solution generated by the removing and containing the non-bound three-dimensional formation powders and the solvent, and preparing a composition B containing the non-bound three-dimensional formation powders and the solvent.

2. The manufacturing method of a three-dimensional structure according to claim 1,
wherein the composition B is prepared by adjusting a viscosity of the composition B based on a viscosity of the composition A, in the preparation of the composition B.

3. The manufacturing method of a three-dimensional structure according to claim 1, further comprising:
forming the layers using the composition A and the composition B.

4. The manufacturing method of a three-dimensional structure according to claim 1, further comprising:
discharging a sacrificial layer formation binding solution for forming a sacrificial layer to an area of an outermost layer on a surface side, which is adjacent to an area to be the outermost layer of the three-dimensional structure among the layers,
wherein an area of the layer for discharging the sacrificial layer formation binding solution is formed by the composition B.

5. A three-dimensional structure manufacturing apparatus which manufactures a three-dimensional structure by laminating layers, the apparatus comprising:
a formation unit in which the three-dimensional structure is formed;
a supply unit which supplies a composition A containing three-dimensional formation powders and a solvent to the formation unit;
a layer formation unit which forms the layers in the formation unit using the composition A;
a discharge unit which discharges a binding solution for binding the three-dimensional formation powders to the layers;
a curing unit which binds the three-dimensional formation powders by curing the discharged binding solution;
a removing unit which removes the non-bound three-dimensional formation powders, using the solvent;
a storage unit which stores a mixed solution generated by the removing unit and containing the non-bound three-dimensional formation powders and the solvent; and
a composition B preparation unit which additionally adds the three-dimensional formation powders to the mixed solution and prepares a composition B containing the three-dimensional formation powders and the solvent.

6. A three-dimensional structure which is manufactured by the manufacturing method of a three-dimensional structure according to claim 1.

7. A three-dimensional structure which is manufactured by the manufacturing method of a three-dimensional structure according to claim 2.

8. A three-dimensional structure which is manufactured by the manufacturing method of a three-dimensional structure according to claim 3.

9. A three-dimensional structure which is manufactured by the manufacturing method of a three-dimensional structure according to claim 4.

10. A three-dimensional structure which is manufactured by the three-dimensional structure manufacturing apparatus according to claim 5.
